(19) United States
(12) Patent Application Publication
(10) Pub. No.: US 2005/0221081 A1
(43) Pub. Date: Oct. 6, 2005

(54) Stabilization of self-assembled monolayers

(76) Inventors: Gang-Yu Liu, Davis, CA (US); Nabil A. Amro, Chicago, IL (US); Guohua Yang, Westmont, IL (US)

Correspondence Address: MORRISON & FOERSTER LLP, 755 PAGE MILL RD, PALO ALTO, CA, 94304-1018, US

(21) Appl. No.: 11/083,739

(22) Filed: Mar. 17, 2005

Related U.S. Application Data
(60) Provisional application No. 60/555,770, filed on Mar. 23, 2004.

(51) Int. Cl. B32B 15/04

(52) U.S. Cl. 428/338; 428/457; 428/420

(57) ABSTRACT

Self-assembled monolayers and other solid support/surface-layer systems are widely used as resists for nanofabrication because of its closely packed structure, low defect density, and uniform thickness. However these resists suffer the drawback of low stability in liquid due to desorption and/or oxidation induced desorption. Stabilized solid support/surface-layer systems and methods of preserving the integrity and structure of self-assembled monolayers on solid surfaces are provided. The method involves adding small amount of amphiphilic molecules, such as DMF and DMSO, into aqueous solutions as preserving media. These molecules adhere favorably to defect sites within monolayers and inhibit the initiation of both known degradation pathways: oxidation and desorption. Also provided are stabilized systems including the solid support/surface-layer system and stabilizing solution, as well as kits of stabilizing solutions for use with various systems.

### CROSS-REFERENCE TO RELATED APPLICATIONS

This application claims benefit of U.S. Provisional Application Ser. No. 60/555,770, filed Mar. 23, 2004 the disclosure of which is incorporated herein by reference in its entirety.

### STATEMENT REGARDING FEDERALLY SPONSORED RESEARCH OR DEVELOPMENT

This invention was made with Government support under CHE0244830 and CHE0210807 awarded by the National Science Foundation (NSF), and 60NANB1D0072 awarded by the National Institute of Standards and Technology (NIST). The Government may have certain rights in this invention.

### REFERENCE TO A COMPACT DISK APPENDIX

Not applicable.

### BACKGROUND OF THE INVENTION

Organothiol self-assembled monolayers (SAMs) on precious metals (Dubois, L. H., Nuzzo, R. G. Annu. Rev. Phys. Chem. 1992, 43, 437-463; Ulman, A. Chem. Rev. 1996, 96, 1533-1554; Schreiber, F. Prog. Surf. Sci. 2000, 65, 151-256.) such as gold have attracted extensive research due to potential applications in corrosion passivation (Laibinis, P. E., Whitesides, G. M. J. Am. Chem. Soc. 1992, 114, 9022-9028; Jennings, G. K., Laibinis, P. E. J. Am. Chem. Soc. 1997, 119, 5208-5214; Zamborini, F. P., Crooks, R. M. Langmuir 1998, 14, 3279-3286), molecular electronics (Tour, J. M. Acc. Chem. Res. 2000, 33, 791-804; Fendler, J. H. Chem. Mat. 2001, 13, 3196-3210), nanolithography (Xia, Y. N., Whitesides, G. M. Annu. Rev. Mater. Sci. 1998, 28, 153-184; Liu, G. Y., Xu, S., Qian, Y. L. Acc. Chem. Res. 2000, 33, 457-466; Piner, R. D., Zhu, J., Xu, F., Hong, S. H., Mirkin, C. A. Science 1999, 283, 661-663), and mimicking of biomembranes (Ulman, A. Chem. Rev. 1996, 96, 1533-1554; Mrksich, M., Whitesides, G. M. Annu. Rev. Biophys. Biomolec. Struct. 1996, 25, 55-78; Liu, G. Y., Amro, N. A. Proc. Natl. Acad. Sci. U.S.A. 2002, 99, 5165-5170). SAMs and processes for making and/or using them have also been disclosed in a number of patents, for example see U.S. Pat. Nos. 5,514,501; 5,885,753, 6,180,239; and 6,518,168. Additional nanofabrication techniques are disclosed in U.S. Pat. Nos. 5,922,214 and 6,635,311.

The realization of these applications critically depends on the long-term stability of SAMs, especially in liquid media. Early reports have shown that alkanethiol SAMs exhibit short-term stabilities at room temperature (Bain, C. D., Troughton, E. B., Tao, Y. T., Evall, J., Whitesides, G. M., Nuzzo, R. G. J. Am. Chem. Soc. 1989, 111, 321-335) which makes SAMs good passivation monolayers in fundamental research. However, recent studies suggest that SAMs readily desorb from the surface upon immersion in organic solvents and aqueous solutions over the course of a few days (Schlenoff, J. B., Li, M., Ly, H. J. Am. Chem. Soc., 1995, 117, 12528-12536; Noh, J., Hara, M. Langmuir 2001, 17, 7280-7285).

Despite the complexity of SAM systems, two main degradation pathways have been identified: direct desorption (Bain, C. D., Troughton, E. B., Tao, Y. T., Evall, J., Whitesides, G. M., Nuzzo, R. G. J. Am. Chem. Soc. 1989, 111, 321-335; Schlenoff, J. B., Li, M., Ly, H. J. Am. Chem. Soc. 1995, 117, 12528-12536; Xu, S., Miller, S., Noh, J., Hara, M. Langmuir 2001, 17, 7280-7285; Xu, S., Miller, S., Laibinis, P. E., Liu, G. Y. Langmuir 1999, 15, 7244-7251) and oxidation-desorption processes (Li, Y. Z., Huang, J. Y., McIver, R. T., Hemminger, J. C. J. Am. Chem. Soc. 1992, 114, 2428-2432; Tarlov, M. J., Burgess, D. R. F., Gillen, G. J. Am. Chem. Soc. 1993, 115, 5305-5306; Scott, J. R., Baker, L. S., Everett, W. R., Wilkins, C. L., Fritsch, I. Anal. Chem. 1997, 69, 2636-2639; Schoenfisch, M. H., Pemberton, J. E. J. Am. Chem. Soc. 1998, 120, 4502-4513; Lee, M. T., Hsuch, C. C., Freund, M. S., Ferguson, G. S. Langmuir 1998, 14, 6419-6423; Poirier, G. E., Herne, T. M., Miller, C. C., Tarlov, M. J. J. Am. Chem. Soc. 1999, 121, 9703-9711).

In the direct desorption process in liquid media, there is strong evidence that alkanethiol SAMs on gold surfaces desorb as disulfide (Nuzzo, R. G., Zegarski, B. R., Dubois, L. H. J. Am. Chem. Soc. 1987, 109, 733-740; Kondoh, H., Kodama, C., Nozoye, H. J. Phys. Chem. B 1998, 102, 2310-2312; Kondoh, H., Kodama, C., Sumida, H., Nozoye, H. J. Chem. Phys. 1999, 111, 1175-1184), similar to the desorption of alkanethiol from Au(111) under ultra high vacuum (UHV) conditions. Chemical equations (1) and (2) represent two possibilities. The first surface reaction can be expressed as,
2RS—Au(s)→RS—SR+2Au(s) (1)
i.e. the adsorbed alkanethiols are in the form of thiolates and desorption follows second-order kinetics (Schlenoff, J. B., Li, M., Ly, H. J. Am. Chem. Soc. 1995, 117, 12528-12536). In the second possibility, adsorbed alkanethiols adopt a dimerized configuration on Au(111) (Fenter, P., Eberhardt, A., Eisenberger, P. Science 1994, 266, 1216-1218). In this case, the surface reaction is represented by
RSSRAu(s)→RS—SR+2Au₍ₛ₎ (2)
which is now expected to follow a first-order kinetics. Radiolabeling studies found that the initial desorption kinetics can be better explained by the first-order model (Schlenoff, J. B., Li, M., Ly, H. J. Am. Chem. Soc. 1995, 117, 12528-12536). The surface coverage vs. time measurements revealed that desorption of alkanethiol SAMs from gold surfaces undergoes two distinct kinetic regimes: initial fast desorption, followed by slow desorption (Schlenoff, J. B., Li, M., Ly, H. J. Am. Chem. Soc. 1995, 117, 12528-12536; Garg, N., Carrasquillo-Molina, E., Lee, T. R. Langmuir 2002, 18, 2717-2726).

In an oxidation-desorption process, it is well established that SAMs on Au exposed to air for prolonged periods quickly oxidize to sulfinates and sulfonates (Li, Y. Z., Huang, J. Y., McIver, R. T., Hemminger, J. C. J. Am. Chem. Soc. 1992, 114, 2428-2432; Tarlov, M. J., Burgess, D. R. F., Gillen, G. J. Am. Chem. Soc. 1993, 115, 5305-5306; Scott, J. R., Baker, L. S., Everett, W. R., Wilkins, C. L., Fritsch, I. Anal. Chem. 1997, 69, 2636-2639; Schoenfisch, M. H., Pemberton, J. E. J. Am. Chem. Soc. 1998, 120, 4502-4513) (see Eqs. 3 and 4);
RS—Au(s)+2O₃→RSO₂Au(s)+2O₂
2RS—Au(s)+4O₃→2RSO₃Au(s)+3O₂ (3)
or
RSSRAu(s)+2O₃→2RSO₂Au(s)+O₂
RSSRAu(s)+4O₃→2RSO₃Au(s)+3O₂ (4)
even in the absence of light. These oxidized species quickly desorb from the surface upon soaking in, or rinsing with, solvents (Scott, J. R., Baker, L. S., Everett, W. R., Wilkins, C. L., Fritsch, I. Anal. Chem. 1997, 69, 2636-2639; Tarlov, M. J., Newman, J. G. Langmuir 1992, 8, 1398-1405; Huang, J. Y., Hemminger, J. C. J. Am. Chem. Soc. 1993, 115, 3342-3343; Garrell, R. L., Chadwick, J. E., Severance, D. L., McDonald, N. A., Myles, D. C. J. Am. Chem. Soc. 1995, 117, 11563-11571).

In addition, the lability of SAMs has been further demonstrated by rapid degradation at elevated temperatures (Bain, C. D., Troughton, E. B., Tao, Y. T., Evall, J., Whitesides, G. M., Nuzzo, R. G. J. Am. Chem. Soc. 1989, 111, 321-335; Garg, N., Carrasquillo-Molina, E., Lee, T. R. Langmuir 2002, 18, 2717-2726) and exchange reactions with a different thiol in various solutions (Chidsey, C. E. D., Bertozzi, C. R., Putvinski, T. M., Mujsce, A. M. J. Am. Chem. Soc. 1990, 112, 4301-4306; Biebuyck, H. A., Bian, C. D., Whitesides, G. M. Langmuir 1994, 10, 1825-1831; Shon, Y. S., Lee, T. R. J. Phys. Chem. B 2000; 104, 8192-8200).

The molecular level view of degradation mechanisms has also been revealed by recent microscopy investigations, such as STM and AFM. It has been reported that degradations of alkanethiol SAMs on Au(111) mainly initiate at defect sites, such as the boundaries of domains and vacancy islands, and then propagate into the closely packed, ordered molecular domains (Noh, J., Hara, M. Langmuir 2001, 17, 7280-7285; Poirier, G. E., Heme, T. M., Miller, C. C., Tarlov, M. J. J. Am. Chem. Soc. 1999, 121, 9703-9711). Surface structural evolutions in the direct desorption and oxidation-desorption processes are illustrated in FIG. 1. It appears that direct desorption mainly takes places at defect sites, where adsorbed thiols are more accessible by solvent molecules, resulting in striped phases and a disordered structure in low coverage areas before a complete depletion (Noh, J., Hara, M. Langmuir 2001, 17, 7280-7285) of the SAM.

In oxidation-desorption processes, it appears that sulfur head groups at defect sites are first oxidized to form organosulfinates and organosulfonates, resulting in the formation of a striped packing arrangement. Additional oxidation of the surface converts the monolayer surface to a commensurate p(5×√3) phase and a disordered structure (including unoxidized thiols and oxidized species) (Poirier, G. E., Herne, T. M., Miller, C. C., Tarlov, M. J. J. Am. Chem. Soc. 1999, 121, 9703-9711). In a number of studies, ozone was identified as the dominant oxidizing agent under ambient conditions (Schoenfisch, M. H., Pemberton, J. E. J. Am. Chem. Soc. 1998, 120, 4502-4513; Poirier, G. E., Herne, T. M., Miller, C. C., Tarlov, M. J. J. Am. Chem. Soc. 1999, 121, 9703-9711; Norrod, K. L., Rowlen, K. L. J. Am. Chem. Soc. 1998, 120, 2656-2657; Zhang, Y. M., Terrill, R. H., Tanzer, T. A., Bohn, P. W. J. Am. Chem. Soc. 1998, 120, 2654-2655).

The activation energy of desorption can be extracted from kinetic measurements. For instance, the activation energy of desorption of alkanethiol SAMs on Au(111) was measured to be 117 to 126 kJ/mol under UHV conditions by temperature programmed desorption (TPD) (Nuzzo, R. G., Zegarski, B. R., Dubois, L. H. J. Am. Chem. Soc. 1987, 109, 733-740; Lavrich, D. J., Wetterer, S. M., Bernasek, S. L., Scoles, G. J. Phys. Chem. B 1998, 102, 3456-3465). In liquid media, solvation energy for organic molecules follows with solvation energy increasing in the order of: thiol or disulfide solution, transition state, and adsorbed thiols. Therefore, the desorption barrier of alkanethiol in solvents is expected to be smaller than that in UHV, as illustrated in FIG. 2. In fact, the activation energy of alkanethiol SAM (chain length of 16-19 carbons) desorption in decalin was measured to be 109 kJ/mol (Garg, N., Carrasquillo-Molina, E., Lee, T. R. Langmuir 2002, 18, 2717-2726).

Previous attempts to prevent and/or slow down both degradation processes have included (1) reducing surface defect density of gold solid supports and monolayer domains by, for example, annealing (Garg, N., Carrasquillo-Molina, E., Lee, T. R. Langmuir 2002, 18, 2717-2726) and underpotential-deposition procedures (Jennings, G. K., Laibinis, P. E. J. Am. Chem. Soc. 1997, 119, 5208-5214; Jennings, G. K., Laibinis, P. E. Langmuir 1996, 12, 6173-6175), (2) modifying adsorbates such as by introducing multiple sulfur-gold interactions (Garg, N., Carrasquillo-Molina, E., Lee, T. R. Langmuir 2002, 18, 2717-2726; Geissler M.; Schmid H; Bietsch A; Michel B; Delamarche E; Langmuir 2002, 18, 2374; Shon, Y. S., Lee, T. R. J. Phys. Chem. B 2000, 104, 8192-8200; Shon, Y. S., Lee, S., Colorado, R., Perry, S. S., Lee, T. R. J. Am. Chem. Soc. 2000, 122, 7556-7563; Whitesell, J. K., Chang, H. K. Science 1993, 261, 73-76) and cross-linking groups within alkyl chains (Clegg, R. S., Reed, S. M., Hutchison, J. E. J. Am. Chem. Soc. 1998, 120, 2486-2487; Cai, M., Mowery, M. D., Menzel, H., Evans, C. E. Langmuir 1999, 15, 1215-1222; Kim, T., Chan, K. C., Crooks, R. M. J. Am. Chem. Soc. 1997, 119,189-193), and (3) storing SAMs under UHV (Poirier, G. E. Langmuir 1999, 15, 1167-1175). The first two approaches involve a greater number of synthetic steps, and result in some improvement, but not elimination, of the degradation, because defects are always present on surfaces. UHV conditions do not generally help SAM applications, which mostly involve liquid phases.

Degradation of Alkanethiol SAMs on Au(111)

While various studies have been performed on SAM desorption in solutions (Bain, C. D., Troughton, E. B., Tao, Y. T., Evall, J., Whitesides, G. M., Nuzzo, R. G. J. Am. Chem. Soc. 1989, 111, 321-335; Schlenoff, J. B., Li, M., Ly, H. J. Am. Chem. Soc. 1995, 117, 12528-12536; Noh, J., Hara, M. Langmuir 2001, 17, 72807285; Jennings, G. K., Laibinis, P. E. Langmuir 1996, 12, 6173-6175) and UHV (Nuzzo, R. G., Zegarski, B. R., Dubois, L. H. J. Am. Chem. Soc. 1987, 09, 733-740; Kondoh, H., Kodama, C. Nozoye, H. J. Phys. Chem. B 1998, 102, 2310-2312, Kondoh, H., Kodama, C., Sumida, H., Nozoye, H. J. Chem. Phys. 1999, 111, 1175-1184; Lavrich, D. J., Wetterer, S. M., Bernasek, S. L., Scoles, G. J. Phys. Chem. B 1998, 102, 3456-3465; Yang, G., Liu, G. Y. J. Phys. Chem. B 2003, 107, 8746-8759; Delamarche, E., Michel, B., Kang, H., Gerber, C. Langmuir 1994, 10, 4103-4108), molecular level investigations on the stability of SAMs in liquid media are still lacking (Noh, J., Hara, M. Langmuir 2001, 17, 7280-7285; Poirier, G. E., Herne, T. M., Miller, C. C., Tarlov, M. J. J. Am. Chem. Soc. 1999, 121, 9703-9711).

As is apparent from the above discussion, compositions and methods for the stabilization of SAMs and other solid support/surface-layer systems, especially those in solution, are needed, as are stabilized solid support/surface-layer systems.

All references, patents, and patent applications cited herein are hereby incorporated by reference in their entirety.

### BRIEF SUMMARY OF THE INVENTION

Provided are compositions and methods for retarding or preventing the degradation of a surface-layer bonded to a solid support, including systems such as monolayers (including SAMs), multilayers or thin films bonded to precious metals or other solid supports. While not wishing to be limited by theory, it is believed that the initial desorption in the systems described herein, including alkanethiol SAMs on gold, at molecular level are retarded or prevented by the methods and compositions described herein. Various stabilizing solutions containing a solvent and stabilizing component were tested for their ability to retard or prevent degradation of surface-layers. Successful stabilizing component candidates include molecules with surface-layer-philic and solvent-philic portions (e.g., in water), such as N,N-dimethylformamide (DMF), dimethyl sulfoxide (DMSO), N,N-dimethylacetamide (DMA), or N-methylformamide (NMA). Molecular-resolution studies using AFM and STM reveal that, stabilizing components associate with surface-layers (e.g., monolayer surfaces) more favorably at defect sites, forming relatively stable adsorbates. Without wishing to be bound by theory, it is also believed that the protective layer formed at defect sites lowers the free energy of adsorbed surface-layers, and increases the activation energy sufficiently to inhibit both known degradation pathways. Regulation of the degradation of surface-layers can be achieved by varying the stabilizing component, its concentration and system temperature.

Particular embodiments include a stabilized system comprising
(a) a solid support;
(b) a surface-layer bonded to at least a portion of a surface of the solid support; and
(c) a stabilizing solution contacted with at least a portion of the surface-layer; wherein the stabilizing solution comprises a solvent and a stabilizing component and wherein the stabilizing component comprises molecules having a solvent-philic portion and a surface-layer-philic portion.

In certain embodiments of the stabilized systems, surface-layers or methods described herein, at least a portion of the surface of the solid support is a metal surface, a semiconductor surface, a metal thin film, or an insulator surface.

In other embodiments of the stabilized systems, surface-layers or methods described herein, at least a portion of the surface of the solid support is a gold surface, silver surface, platinum surface, palladium surface or copper surface.

In some embodiments of the stabilized systems, surface-layers or methods described herein, the solid support comprises a metal thin film on a mica surface, a silicon wafer surface, a glass surface, a quartz surface, a plastic surface, a polymeric surface or a waveguide. In some embodiments, the metal thin film is gold. In some embodiments, the solid support includes a flat surface, a micro-particle surface, or a nano-particle surface.

In certain embodiments of the stabilized systems, surface-layers or methods described herein, at least a portion of the surface-layer is a monolayer, a multilayer, or a thin film. In particular embodiments, the monolayer is a self-assembled monolayer. In other embodiments, at least a portion of the surface-layer is a self-assembled monolayer made of alkyl containing molecules. In certain embodiments, the surface-‘layer’ is a self-assembled monolayer made of a mixture of types of molecules.

In particular embodiments of the stabilized systems, surface-layers or methods described herein, at least a portion of the surface-layer is a self-assembled monolayer made of molecules each containing at least one surface-adhesive head group, a linker group and at least one terminal group. In certain embodiments, the surface-layer is a self-assembled monolayer made of a mixture of two or more different types of molecules. The two or more different types of molecules may differ in their surface-adhesive head groups, linker groups or terminal groups or any combination of these groups.

In some embodiments of the stabilized systems, surface-layers or methods described herein, at least one surface-adhesive head group may be a thiol.

In certain embodiments of the stabilized systems, surface-layers or methods described herein, the linker group contains an alkyl group, polyethylene glycol (PEG), an amide group, or combinations thereof.

In particular embodiments of the stabilized systems, surface-layers or methods described herein, the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD (Arg-Gly-Asp peptide) or a -carbohydrate, wherein each R¹ and R² is, independently, a straight or branched chain alkyl or aryl. In certain other embodiments, the at least one terminal group is, independently, one or more of —CH₃, —CF₃, —CHO, —COOH, —SH, —OH, or -biotin.

In some embodiments of the stabilized systems, surface-layers or methods described herein, the alkyl containing molecules contain a C₁-C₃₀ alkyl group, at least a portion of the solid support surface is a gold surface, and the alkyl-containing molecules are bonded to the gold surface via a thiol moiety. In certain embodiments of the stabilized systems, surface-layers or methods described herein, the alkyl-containing molecules may include a mixture of two or more different types of alkyl-containing molecules. For example, the two or more different types of alkyl-containing molecules may include different C₁-C₃₀ alkyl groups or may include different substituents.

In particular embodiments of the stabilized systems, surface-layers or methods described herein, the surface of the solid support is immersed in the stabilizing solution.

In some embodiments of the stabilized systems, surface-layers, methods or kits described herein, the solvent is water, an aqueous solvent, an aqueous buffer, an organic solvent, a protic -solvent, an aprotic solvent or, the solvent is a mixture of two or more of water, an aqueous solvent, an aqueous buffer, an organic solvent, a protic solvent, or an aprotic solvent. In certain embodiments, the solvent is an aqueous buffer. In other embodiments, the solvent is water. In particular embodiments, the solvent is an aqueous buffer.

In some embodiments of the stabilized systems, surface-layers, methods or kits described herein, the solvent comprises minor components of non-reactive additives with a concentration of less than 15% mole fraction.

In some embodiments of the stabilized systems, surface-layers, methods or kits described herein, the stabilizing component contains amphiphilic molecules.

In some embodiments of the stabilized systems, surface-layers, methods or kits described herein, the solvent is water or an aqueous buffer, and the stabilizing component contains molecules of the formula AB, wherein, A is a solvent-philic moiety; and, Bₙ is a surface-philic moiety, where n may be, independently, 1, 2 or 3, and each B may be the same or different. In particular embodiments, A contains an amide, —OH, ether, ester, amine, or sulfoxide; and, each B is, independently, a straight or branched alkyl group or aryl group. In particular embodiments, A is a formamide, a sulfoxide, or an acetamide.

In particular embodiments of the stabilized systems, surface-layers, methods or kits described herein, the solvent is water or aqueous buffer and the stabilizing component contains N,N-dimethylformamide, dimethyl sulfoxide, N,N-dimethylacetamide, N-methylformamide, or a mixture of two or more thereof.

In some embodiments of the stabilized systems, surface-layers, methods or described herein, the stabilizing component contains molecules that associate preferentially with defect sites in a surface-layer. In certain embodiments described herein, the defect sites are one or more of domain boundaries, holes, pits, cracks, dislocations, island edges, or step edges.

The stabilized system of claim 1, wherein the concentration of the stabilizing component in the stabilizing solution is equal to or less than about 45% by volume.

In some embodiments of the stabilized systems, surface-layers, methods or kits described herein, the concentration of the stabilizing component is between about 0.01% by volume and about 15% by volume. In some embodiments the concentration of the stabilizing component is between about 0.1% by volume and about 15% by volume.

In certain embodiments of the invention is provided a stabilized surface-layer, comprising
(a) a self-assembled monolayer of C₁-C₃₀ alkyl group containing molecules bonded to at least a portion of a surface of a solid support; and
(b) a stabilizing solution contacting at least a portion of the self-assembled monolayer;
   wherein the stabilizing solution comprises water and a stabilizing component containing amphiphilic molecules.

In certain other embodiments of the invention is provided a stabilized surface-layer, comprising
(a) a self-assembled monolayer, each molecule of the self-assembled monolayer containing a C₁-C₃₀ alkyl linker, a head group bonded to at least a portion of a surface of a solid support and at least one terminal group; and
(b) a stabilizing solution contacting at least a portion of the self-assembled monolayer; wherein the stabilizing solution comprises water and a stabilizing component containing amphiphilic molecules.

In some embodiments of the stabilized systems, surface-layers, methods or kits described herein, the stabilizing component contains N,N-dimethylformamide, dimethyl sulfoxide, N,N-dimethylacetamide, N-methylformamide or a mixture of two or more thereof.

In some embodiments of the stabilized systems, surface-layers, methods or kits described herein, the concentration of the stabilizing component in the stabilizing solution is equal to or less than about 45% by volume. In certain embodiments, the concentration of the stabilizing component is between about 0.01% by volume and about 15% by volume. In certain embodiments the concentration of the stabilizing component is between about 0.1% by volume and about 15% by volume. In other embodiments, the concentration of the stabilizing component is between about 2% by volume and about 8% by volume. In some embodiments, the concentration of the stabilizing component is between about 4% by volume and about 7% by volume. In other embodiments, the concentration of the stabilizing component is about 5% by volume.

In some embodiments of the stabilized systems, surface-layers, methods or kits described herein, the stabilizing component contains dimethyl sulfoxide molecules, N,N-dimethylformamide molecules, or a mixture thereof.

In particular embodiments of the stabilized systems, surface-layers, or methods described herein, the surface-layer is immersed in the stabilizing solution.

In certain embodiments is provide a stabilized surface-layer, comprising
(a) a solid support comprising a pre-engineered surface-layer; and
(b) a stabilizing solution contacting at least a portion of the surface-layer;
   wherein the stabilizing solution comprises a solvent and a stabilizing component and wherein the stabilizing component comprises molecules having a solvent-philic portion and a surface-layer-philic portion.

In some embodiments of the stabilized systems, surface-layers, or methods described herein, the stabilizing component contains molecules of N,N-dimethylformamide, dimethyl sulfoxide, N,N-dimethylacetamide, N-methylformamide or a mixture of two or more thereof.

In some embodiments of the stabilized systems, surface-layers, methods or kits described herein, the solvent is water or aqueous buffer and the stabilizing component is an amphiphilic molecule or mixture of amphiphilic molecules. In particular embodiments thereof, the stabilizing component contains molecules of N,N-dimethylformamide, dimethyl sulfoxide, N,N-dimethylacetamide, N-methylformamide or a mixture of two or more thereof.

In some embodiments of the stabilized systems, surface-layers, or methods described herein, the pre-engineered surface-layer contains microstructures, nanostructures, or a mixture thereof. In some embodiments described herein, the microstructures are prepared by microcontact printing, photolithography, micromachining, soft lithography, or a combination of two or more thereof. In particular embodiments as described herein, the nanostructures are prepared by nanografting, scanning probe lithography, mixing of multicomponents, nanoimprint, e-beam lithography, atom lithography, x-ray lithography, dip pen nanolithography, or a combination of two or more thereof.

In some embodiments of the stabilized systems, surface-layers, or methods described herein, the microstructures, nanostructures, or mixture thereof are surrounded by a monolayer, multilayer or thin film. In certain embodiments, the monolayer is a self-assembled monolayer.

In some embodiments of the stabilized systems, surface-layers, or methods described herein, at least a portion of the pre-engineered surface-layer is a self-assembled monolayer made of molecules each containing at least one surface-adhesive head group, a linker group and at least one terminal group. In certain embodiments, the surface-layer is a self-assembled monolayer made of a mixture of two or more different types of molecules. The two or more different types of molecules may differ in their surface-adhesive head groups, linker groups or terminal groups or any combination of these groups.

In particular embodiments of the stabilized systems, surface-layers, methods or kits described herein, the surface-adhesive head group is a thiol and the linker is a C₁-C₃₀ alkyl group. In certain embodiments of the stabilized systems, surface-layers or methods described herein, the alkyl-containing molecules may include a mixture of two or more different types of alkyl-containing molecules. For example, the two or more different types of alkyl-containing molecules may include different C₁-C₃₀ alkyl groups or may include different substituents.

In some embodiments of the stabilized systems, surface-layers, methods or kits described herein, the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD (Arg-Gly-Asp peptide) or a -carbohydrate, wherein each R¹ and R² is, independently, a straight or branched chain alkyl or aryl. In certain embodiments, the at least one terminal group is, independently, one or more of —CH₃, —CF₃, —CHO, —COOH, —SH, —OH, or -biotin.

In particular embodiments, at least a portion of the surface-layer is a self-assembled monolayer made of molecules each containing at least one surface-adhesive head group, a linker group and at least one terminal group. In certain embodiments, the surface-adhesive head group is a thiol and the linker is a C₁-C₃₀ alkyl group. And, in some embodiments, the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD or a -carbohydrate, wherein each R¹ and R² is, independently, a straight or branched chain alkyl or aryl. And, in other embodiments, the at least one terminal group is, independently, one or more of —CH₃, —CF₃, —CHO, —COOH, —SH, —OH, or -biotin.

In some embodiments of the stabilized systems, surface-layers, methods or kits described herein, the pre-engineered surface layer further comprises one or more biomolecules.

In some embodiments of the stabilized systems, surface-layers, methods or kits described herein, the one or more biomolecules are, independently, antibodies, antigens, oligonucleotides, DNA, RNA, oligopeptides, peptides, proteins, or a mixture of two or more thereof.

In certain embodiments is provided a kit for use in stabilizing a system, the kit comprising a stabilizing solution and instructions for contacting the stabilizing solution with a surface-layer bonded to the surface of a solid support; wherein the stabilizing solution comprises a solvent and a stabilizing component containing amphiphilic molecules.

In certain embodiments of the kits as described herein, the solvent is water or aqueous buffer. In some embodiments the solvent is water. In particular embodiments, solvent is an aqueous buffer.

In certain embodiments of the kits as described herein, the amphiphilic molecules are N,N-dimethylformamide, dimethylsulfoxide, N,N-dimethylacetamide, N-methylformamide or a mixture of two or more thereof. In particular embodiments, the stabilizing component contains dimethylsulfoxide molecules, N,N-dimethylformamide molecules, or a mixture thereof.

In some embodiments of the kits as described herein, the concentration of the stabilizing component in the stabilizing solution is equal to or less than about 45% by volume. In other embodiments the concentration of the stabilizing component is between about 0.01% by volume and about 15% by volume. In particular embodiments the concentration of the stabilizing component is between about 0.1% by volume and about 15% by volume. In still other embodiments the concentration of the stabilizing component is between about 2% by volume and about 8% by volume. In some embodiments, the concentration of the stabilizing component is between about 4% by volume and about 7% by volume. In other embodiments, the concentration of the stabilizing component is about 5% by volume.

In particular embodiments is provided a method for stabilizing a surface-layer bonded to at least a portion of a surface of the solid support, the method comprising contacting the surface-layer with a fluid comprising a stabilizing component containing molecules that associate preferentially with defect sites in the surface-layer.

In certain embodiments of the described method, the stabilizing component is dissolved in a solvent.

In some embodiments of the described method, the molecules that associate preferentially with defect sites in the surface-layer are amphiphilic molecules. In particular embodiments, the amphiphilic molecules are N,N-dimethylformamide, dimethyl sulfoxide, N,N-dimethylacetamide, N-methylformamide or a mixture of two or more thereof. In other methods, the amphiphilic molecules are dimethyl sulfoxide, N,N-dimethylformamide, or a mixture thereof.

In certain embodiments of the described method, the stabilizing component is dissolved in water or aqueous buffer.

In some embodiments of the described method, the concentration of the stabilizing component in the stabilizing solution is equal to or less than about 45% by volume. In other embodiments the concentration of the stabilizing component is between about 0.01% by volume and about 15% by volume. In certain other embodiments the concentration of the stabilizing component is between about 0.1% by volume and about 15% by volume. In still other embodiments the concentration of the stabilizing component is between about 2% by volume and about 8% by volume. In some embodiments, the concentration of the stabilizing component is between about 4% by volume and about 7% by volume. In other embodiments, the concentration of the stabilizing component is about 5% by volume.

### BRIEF DESCRIPTION OF THE DRAWINGS

FIG. 1 is a schematic diagram illustrating two main pathways for the initial degradation of SAMs on gold via desorption and oxidation-desorption processes. Critical structural evolution and morphological changes are included.

FIG. 2 is a qualitative/schematic diagram illustrating the reaction dynamics of the initial desorption process of SAMs from gold. UHV medium is plotted in contrast to the solution phase.

FIG. 3 shows the stability of octadecanethiol nanostructures in the decanethiol matrix in 2-butanol. Six images are shown representing critical moments of desorption. A 75×85 nm² rectangle and a 15×15 nm² square [A] of octadecanethiol were produced by nanografting in a 0.2 mM solution. The smaller pattern is connected to the larger pattern by a 10×5 nm² octadecanethiol bridge and appears less sharp due to tip convolution. Desorption processes with immersion time (in hours) are shown from [B] to [F]. After 140 h, few of the matrix decanethiol molecules remain and ˜50% of the original octadecanethiol nanostructures detach as well. [G] is the plot of the surface coverage versus immersion time measured from AFM topographs during desorption.

FIG. 4 shows STM topographs of decanethiol SAMs after exposure to various environments. Image [A] was acquired for a freshly prepared decanethiol SAM in a 1 mM thiol/ethanol solution after less than 30-minute exposure in air. Image [B] was taken after ambient exposure for one day. Image [C] showed the surface topograph after 8-day soaking in pure water. In [D], the SAM was imaged after 8-day immersion in sec-butanol at room temperature, where significant desorption occurred. All STM images were taken under I=30 pA, and V=1.0 V.

FIG. 5 shows the stabilization of octadecanethiol nanostructures in the decanethiol matrix in a 5% DMF aqueous solution. [A] A 500×500 nm² decanethiol SAM taken in a 0.2 mM octadecanethiol solution of a 5% DMF aqueous mixture. Two octadecanethiol nanostructures (a 10×10 nm² island and 150×150 nm² square) were then produced using nanografting, followed by replacing the imaging medium with 5% DMF in water. [B] AFM topograph acquired immediately after nanografting and medium change. [C] Topographic image taken after 65 h immersion. [D] Topographic image acquired after 114 h immersion in the 5% DMF and water solution.

FIG. 6 shows desorption inhibition revealed by STM. Topographs of decanethiol monolayers were acquired after 8-day immersion in 5% DMF and water [A], 5% DMSO and water [B], and 5% DMF and 1×PBS buffer solutions [C], respectively. Image [D] was acquired after 10-day immersion in a continuously stirred 5% DMF aqueous solution. No desorption was observed in experiments [A]-[D].

FIG. 7 shows the influence of DMF concentrations on desorption inhibition. STM topographs of decanethiol SAMs exposed in DMF aqueous solutions for 45 days with different DMF concentrations of [A] 0%, [B] 1%, [C] 5%, and [D] 20%. The optimal DMF concentration range for desorption inhibition is from 0.5% to 10%.

FIG. 8 shows the influence of immersion temperature on the desorption. STM topographs of decanethiol SAMs after being heated at 65° C. for 50 min in pure sec-butanol [A], and 5% DMF aqueous solutions [B], respectively. [C] STM topograph after 120-min heating at 65° C. in a 5% DMF aqueous solution.

FIG. 9 shows STM topographs of unwashed decanethiol SAMs on gold in 5% DMF and 5% DMSO aqueous solutions. STM images [A] and [B] show the surface structures (100×100 nm²) of decanethiol SAMs after 45-day immersion in 5% DMF and 5% DMSO aqueous solutions, respectively. The corresponding high-resolution views (10×10 nm²) are shown in [C] and [D]. The bright features are attributed to the adsorbed amphiphilic molecules.

FIG. 10 shows the mechanism of desorption inhibition of alkanethiol SAMs in amphiphile and water. [A] Schematic diagram illustrates the adsorption of DMF molecules on SAM surfaces, and the preferred attachment to defect sites. [B] The quantitative free energy diagram for the initial desorption process of decanethiol under various environments.

FIG. 11 shows AFM topographs showing the results of fabrication of different functionalities of nanostructures in a ternary mixture. [A] The acronym “DMF” fabricated using nanografting in solution of 5% DMF/water containing 0.1 mM octadecanethiol molecules; [B] shows the fabrication of two square patterns, 70×70 nm² and 90×90 nm², with a spacing of 100 nm of HOOC(CH₂)₂SH was grafted onto the prefabricated CH₃(CH₂)₁₇SH; [C] shows that in air or pure water, where thiols exhibit little solubility, most of the displaced molecules remained weakly attached to the gold substrate; [D] shows the Chinese word for “molecule” nanografted onto a decanethiol matrix; [E] shows a 100×100 nm² aldehyde terminated positive pattern grafted onto a hexanethiol SAM in a ternary mixture of 5% DMF/Water containing 0.1 mM of C₁₀CHO; [F] shows a 150×150 nm² HS(CH₂)₁₅COOH square nanopattern, grafted within a matrix of CH₃(CH₂)₉S/Au(111); [G] shows several aldehyde-terminated negative patterns of CH₃(CH₂)₉CHO that were grafted onto a octadecanethiol SAM in a ternary mixture of DMF/water/thiol mixture.

FIG. 12 shows AFM topographs illustrating specific antibody-antigen recognition for proteins immobilized on nanopatterns as viewed by SFMI. [A] Nanopatterns of mercapto-undecanal: 250×250 nm², 100×100 nm², with a linewidth of 25 nm for the two letters. An incomplete pattern 300×300 nm² on the right (within box) was formed by using a smaller fabrication force. [B] The same area as in [A] after immersing in a 0.01 mg/ml solution of rabbit IgG for 3 min followed by washing. [C] The same area as [A] and [B] after introducing mouse anti-rabbit IgG, in which the patterns display an increase in height, indicating specific binding of antibody to the immobilized protein. [D-F] show higher-resolution topographic images that were acquired by zooming into the area indicted by the box in [A-C]. [G-I] show cursor profiles corresponding to the area within the box depicted in higher-resolution in [D-F] following the fabrication and recognition process. Black and striped areas represent the matrix and patterned SAM regions, respectively. The white region corresponds to adsorbed rabbit IgG, while the gray area represents the secondary IgG molecules. An increase in height (compare cursor [B] and [D]) is observed, which suggests specific binding of antibody to antigen occurs.

FIG. 13 shows STM topographs of a mixed SAM, formed from hexanethiol and decanethiol, upon 36 days soaking in 5% DMF/water solvent. Surface features, such a single atomic steps of gold and etch pits of SAMs are clearly visible from the topograph (left) and corresponding cursor profiles (right). The nanodomains are visible in the zoom-in scan (bottom).

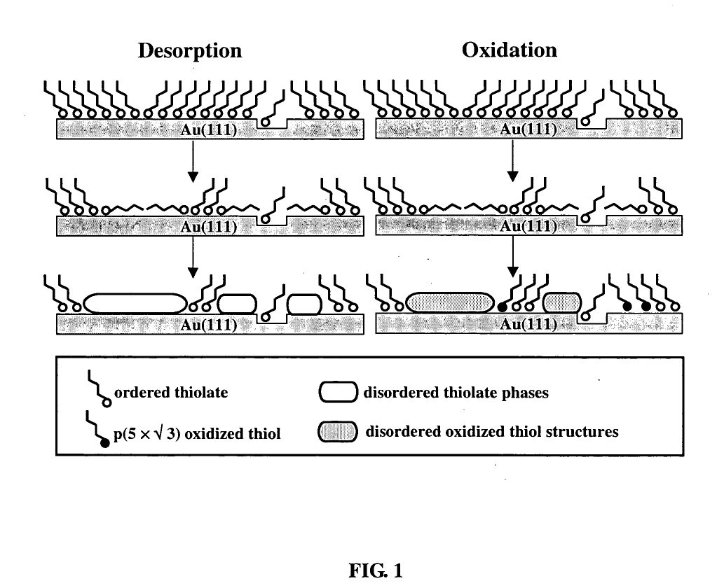

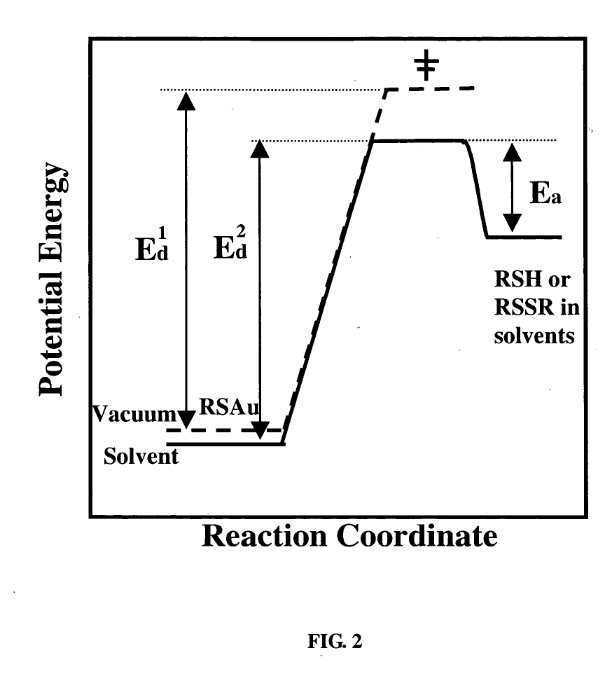

### DETAILED DESCRIPTION OF THE INVENTION

It has been demonstrated that by curing a stabilizing solution comprising a solvent and a stabilizing component, it is possible to stabilize a surface-layer bonded to a solid support. As a non-limiting example of such a stabilized system, an alkyl thiol self-assembled monolayer (SAM) bonded to a gold surface is stabilized (i.e., degradation of the integrity of the SAM layer is retarded or prevented) when the SAM-solid support system is contacted with a stabilizing solution of DMF in water. This example is described in detail below.

Below are described stabilizing solutions i.e., solvents and stabilizing components that may be used, surface-layers that may be stabilized, and solid supports to which the surface layers may be bonded. The stabilized systems, surface-layers and methods of the present invention also provide stabilizing media that can preserve the integrity and structure of patterned micro and nanostructures of surface layers on a solid support. Also provided are specific non-limiting examples of such stabilized systems. First are provided various definitions of terms used herein.

Definitions

As used herein, the term “defect” or “defect site”, and variations thereof, are used interchangeably and refer to imperfections, discontinuity(ies), and/or anomalies at a molecular or macromolecular level in a surface-layer. A defect may also be characterized as a region (including one or more molecules) which is disordered or discontinuous, especially in comparison to the surrounding area. Examples of types of defects include, but are not limited to, vacancy islands, domain boundaries, grain boundaries, point defects, substitution defects, holes, pits, cracks, dislocations, island edges, or step edges, or combinations of two or more thereof.

When used herein, such as in the description of the interaction between the surface-layer and the solid support, the term “bonded”, or variations thereof (e.g., bonding, etc.), includes generally any interaction capable of associating the surface-layer with a surface of a solid support. Bonding interactions include but are not limited to interactions such as covalent, ionic, dative, hydrogen, Van der Waals, hydrophobic-hydrophilic, chemisorption, dispersion forces, London forces and any combinations of these. In certain embodiments, the interaction will be covalent, ionic, hydrophobic-hydrophilic, or combinations thereof.

The terms “alkyl” and “aryl” are as understood by those in the art. Alkyl groups, unless explicitly stated otherwise, can be either straight or branched chains. Alkyl groups and aryl groups can each be independently substituted with by one or more substituent groups, unless explicitly stated otherwise. Suitable substituent groups include halogens (e.g., —Cl, —Br, —I, —F, etc.), hydroxy (—OH), amido, amino, substituted amino, carboxy (—COOH), and other substituents known to those of skill and disclosed in the art and references cited herein.

The term “nanostructure(s)” can be used herein to refer to patterns of surface-layers bonded to a solid support at the nanometer scale. Similarly, the term “microstructure(s)” can be used to refer to patterns of surface-layers bonded to a solid support at the micron scale.

Stabilized Systems

The stabilized systems described herein are generally comprised of a solid support, a surface-layer bonded to at least a portion of a surface of the solid support and a stabilizing solution contacted with at least a portion of the surface-layer. The stabilizing solution comprises a stabilizing component and a solvent. Various solid supports, surface-layers, solvents and stabilizing components that may be used are described in the sections below.

It has been found that contacting the stabilizing solutions as described herein with a surface-layer bonded to a solid support stabilized the surface-layer. Such stabilization can be useful in various situations including, but not limited to, increasing the shelf-life of a SAM resist layer bonded to a solid support such as a semiconductor, silicon wafers with monolayers, multilayers, or thin films which incorporate molecules of interest, including, for example, biomolecules (e.g., antibodies, antigens, proteins, peptides, oligonucleotides, oligopeptides, RNA, DNA, etc.), small molecules (e.g., inorganic or organic) or other applications.

Solid Supports

As used herein, the term “solid support” refers generally to any solid component having a surface at least a portion of which is capable of bonding to a surface-layer.

Solids are the preferred solid supports. The solid support will have one or more surfaces and surface-layers may bond to one or more of these surfaces. It is also intended that organic thin films, lipid bilayers, and langmuir films can be considered solid supports. The surfaces of the solid support may generally be of any topology, including smooth surfaces, stepped surfaces, disordered surfaces or surfaces with any combination of the foregoing.

Suitable solid supports include but are not limited to metals (including precious or other metals), semiconductors (e.g., gallium arsenide, indium phosphide, mercury cadmium telluride, etc.), amorphous solids, crystals, crystalline solids, insulators (e.g., silicon oxide (e.g., silicon wafers), quartz, glass, etc.), and solids containing mixtures of two or more of these, or, solids which are characterized in that at least a portion of the solid is coated with the solid support (or mixtures thereof) as disclosed herein. Also included are cantilever supports (e.g., for use as sensors for small molecules, biomolecules, etc.) The cantilever may be a coated solid as described in greater detail herein, or may be coated directly with the surface-layer (e.g., SAMs, etc.) and may be formed of silicon nitride.

In certain embodiments, suitable solid supports may include bulk and thin films of gold, silver, copper, tungsten, platinum, iridium, palladium, rhodium, osmium, ruthenium, metal oxide, gallium arsenide, indium phosphide, si-wafers, mica, plastics, polymers, glasses, etc., as will be appreciated by those of skill in the art.

In certain embodiments, metal solid supports may include precious metals, such as, but not limited to, gold (Au), silver (Ag), platinum (Pt), palladium (Pd), iridium (Ir) or mixtures of two or more of these. Other metals include copper (Cu). In some embodiments, gold or silver is used as a solid support. In some embodiments, the metal solid support may form the surface of the solid support as in, but not limited to, a metal thin film. For example, a gold surface, silver surface, platinum surface, palladium surface or copper surface. Other thin films (e.g., polymer thin films, etc.) may also be applied to at least a portion of a coated solid.

In some embodiments, the solid support is a coated solid (e.g., a thin film (solid support) coated on a solid) where the solid has at least a portion of its surface or surfaces coated with one or more of the disclosed solid support materials, or mixtures thereof. In some embodiments, at least about 10%, about 20%, about 25%, about 30%, about 35%, about 40%, about 45%, about 50%, about 60%, about 75%, about 80%, about 90%, about 95%, about 98%, about 99% of the surface of the solid is coated with one or more solid support materials, or mixtures thereof. Examples of solids which are suitable for coating by the solid support material, include but are not limited to glass, mica, quartz, silicon wafers, plastics, polymers, cantilevers, or waveguides.

As will be appreciated by those of skill in the art, coated solids, will remain stable (e.g., must remain associated as a “coated solid”, without significant loss of adhesion of the solid support coating to the solid) under the conditions and time intended for the use and storage of the stabilized solid support/surface-layer system.

Surface-Layers

As used herein, the term “surface-layer” refers generally to any composition capable of bonding to at least a portion of a surface of the solid support. Surface-layers include but are not limited to monolayers (e.g., self-assembled monolayers (SAMs)), multilayers (e.g., molecular layer of greater than one molecule of thickness); semiconductors (e.g., GaAs, InP, etc.), insulators, and thin films (e.g., polymer, metal (as described herein), etc.). The term surface-layer is intended to be inclusive of all types of surface-layers, including pre-engineered surface layers, which are described in greater detail below. The term “surface-layer” is also intended to encompass where surface-layers are made of a mixture of two or more components. For example, a surface-layer that is a SAM formed from two or more different types of molecules that differ by the inclusion of one or more different groups that make up the SAM (e.g., the two or more different types of molecules may differ in their surface-adhesive head groups, linker groups or terminal groups or any combination of these groups.). One example would be a SAM fabricated from two or more types of alkyl-containing molecules where the length of the alkyl moiety differs for one or more portion of the molecules.

As will be appreciated by those of skill and described in the art, most molecules of interest, including biomolecules, can be functionalized (e.g., with reactive moieties such as, but not limited to, thiol groups, spacers or combinations thereof) such that they can be used in the systems, methods and kits described herein. Exemplary reactive moieties and spacers for functionalization of molecules of interest are known to those of skill and described in the art, including the references cited herein. Additional exemplary materials for functionalization of molecules of interest includes HSCₙX, where X can be —COOH, —NH₂, —CHO, —SH, -biotin, etc. and Cₙ represents a spacer or the molecule of interest.

The molecules of interest may be, for example attached to the monolayers, multilayers, or thin films of the systems described throughout. Exemplary molecules of interest include biomolecules (e.g., biotin, proteins, oligonucleotides, DNA, RNA, proteins, peptides, oligopeptides, antibodies, antigens, etc.), sensors (e.g., for biologically active species, inorganic species, organic species, small molecules, etc.). See for example: “Fabrication and Imaging of Nanometer-Sized Protein Patterns” Wadu-Mesthrige, K.; Xu, S.; Amro, N. A.; Liu, G.-Y.; Langmuir, 1999, 15, 8580-8583; “Immobilization of Proteins on Self-Assembled monolayers”, Wadu-Mesthrige, K.; Amro, N. A.; Liu, G.-Y. Scanning, 2000, 22, 380-388. “Fabrication of Nanometer-Sized Protein Patterns Using atomic Force Microscopy and Selective Immobilization”, Wadu-Mesthrige, K.; Amro, N. A.; Garno, J. C.; Liu, G.-Y.; Biophysical J., 2001, 80, 1891-1899. “Positioning Proteins on Surfaces: A Nanoengineering Approach to supramolecular Chemistry”, Liu, G.-Y.; Amro, N. A. Proceedings of the National Academy of Science, USA 2002, 99, 5165-5170).

Included as suitable SAMs for surface-layers are SAMs comprising alkyl-containing molecules capable of bonding to the surface of the solid support. These alkyl-containing SAMs include but are not limited to C₁-C₃₀ straight or branched chain alkyl groups which can be bonded to the surface of the solid support layer via a variety of reactive head group moieties, including, but are not limited to, thiol groups. In some embodiments, the alkyl component of the SAM is a C₁-C₅, C₁-C₁₀, C₁-C₁₅, C₁-C₂₀, C₅-C₂₀ or C₁₀-C₂₀ alkyl chain. The alkyl chain may be straight or branched.

Additional suitable SAMs are included as surface-layers are SAMs comprising alkyl-containing molecules capable of bonding to the surface of the solid support. These alkyl-containing SAMs include but are not limited to C₁-C₃₀ straight or branched chain alkyl groups which can be bonded to the solid support layer via a variety of reactive moieties, including, but not limited to, thiol groups. In some embodiments the SAM may include a mixture of two or more types of alkyl-containing molecules where the alkyl portion of the molecules are different. For example, where the alkyl chain length is different (e.g. C₆ and C₁₀) or where the alkyl groups bear different substituents, or any combinations of the foregoing.

For example, compounds of the formula R SH, R′SSR″, R′SR″, R′CN, R′COOH, or ArR′SH can be used to pattern gold or other metal solid supports. In the above formula, R′ and R″ have the formula X(CH₂)ₘ; where m may be from 0 to 30; X may be —CH₃, —CF₃, —COOH, —SH, —OH, oligo(ethylene glycol), —NH₂, -halogen, -glucose, -maltose, -biotin, a nucleic acid (oligonucleotide, DNA, RNA, etc.), a protein (e.g., an antibody or enzyme) or a ligand (e.g., an antigen, enzyme solid support or receptor); Ar is an aryl group.

In some embodiments, at least a portion of the surface-layer is a SAM made of molecules each containing at least one surface-adhesive head group, a linker group and at least one terminal group. In certain embodiments, the surface-layer is a self-assembled monolayer made of a mixture of two or more different types of molecules. The two or more different types of molecules may differ in their surface-adhesive head groups, linker groups or terminal groups or any combination of these groups.

As used herein, the term “surface-adhesive head group” is used to described the portion of a SAM which preferentially bonds or associates with the solid support. Examples of surface-adhesive head groups include, for example, a thiol group.

The term “linker group” refers to the portion of a SAM which links the surface-adhesive head group(s) and the terminal group(s). Examples of linkers groups include alkyl groups (as described herein), polyethylene glycol (PEG) moieties, amide groups, or combinations thereof. As will be appreciated by those of skill in the art, it is possible to have more than one terminal group and/or surface-adhesive head group linked via the linker group. These groups may be independently selected and may be the same or different.

“Terminal group(s)” is used herein to refer to the portion of a SAM which is linked to the surface-adhesive head group(s) via the linker. In certain embodiments, the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD (Arg-Gly-Asp peptide) or a -carbohydrate, where each R¹ and R² can be, the same or different and, independently, a straight or branched chain alkyl (e.g., —CH₃, CH₂CH₃, —CH(CH₃)₂, —CH₂CH(CH₃)₂, etc.) or aryl. In certain embodiments, the at least one terminal group is, independently, one or more of —CH₃, —CF₃, —CHO, —COOH, —SH, —OH, or -biotin. Each terminal group and each R¹ and R² can be independently selected. Alkyl and aryl groups, independently, may be substituted or unsubstituted.

In some embodiments of the above-described surface-layers, the surface-layer is a pre-engineered surface layer. As used herein, the term “pre-engineered surface layer” refers to a surface-layer which has been engineered or fabricated prior to use and/or inclusion in the stabilized systems (for example, prior to the addition of the stabilizing solution, including pre-engineered surface-layers which can be commercially purchased or commissioned to desired specifications), stabilized surfaces or methods described herein. The surface-layers may be modified or engineered by any methods known to those in the art which are suitable to achieve the desired characteristics for the pre-engineered surface-layer. As will be appreciated by those of skill, the desired characteristics for the engineering of the surface-layer will depend upon the desired use for the particular system or stabilized surface.

In some embodiments, the “pre-engineered” surface-layer will include microstructures, nanostructures, or mixtures of both structures. In certain embodiments, the microstructures, nanostructures, or mixtures thereof may be surrounded by the monolayers, multilayers or thin films as described herein. In particular embodiments, the monolayer may be a SAM.

The microstructures may prepared by any of the techniques known in the art, including but not limited to microcontact printing, photolithography, micromachining, soft lithography, or a combination of one or more of these techniques, or techniques known in the art.

The nanostructures may prepared by any of the techniques known in the art, for example, nanografting, scanning probe lithography, mixing of multicomponents, nanoimprint, e-beam lithography, atom lithography, x-ray lithography, dip pen nanolithography, or a combination of one or more these techniques or those in the art, including, for example desorption techniques such as laser-focused atomic desorption, definition and selective deposition processes, etc.

In some embodiments, the pre-engineered surface layer may also include functionalization with a molecule of interest. Molecules of interest, including biomolecules and others, are described in greater detail above, and in the cited references.

Stabilizing Solution

Stabilizing Component

As disclosed herein, the stabilizing solution comprises a solvent and a stabilizing component.

It is noted that the terms “component” and “agent”, including common variations thereof, can be used interchangeably herein. Generally, a stabilizing component contains molecules having a surface-layer-philic portion and a solvent-philic portion. The stabilizing component can contain one type of molecule or can contain more than one type of molecule. For example, DMF and DMSO are possible molecules that can be used in the stabilizing component, and non-limiting examples of a stabilizing component are DMF, DMSO, or a mixture of both DMF and DMSO.

The terms “surface-layer-philic” and “solvent-philic” refer to moieties (e.g., portions of the stabilizing component molecule) which preferentially interact with the surface-layer or the solvent, respectively. The term “stabilizing component” as described herein can be used to describe either a single molecule which contains moieties in which one portion of the molecule is preferentially solvent-philic and one portion of the molecule is preferentially surface-philic, or a combination of more than one of such molecules (e.g., a stabilizing solution can include water, DMF and DMSO, water and DMF, or water and DMSO).

In one embodiment, molecules in the stabilizing component preferentially associate with defect sites in the surface-layer. The term “preferentially associate with defect sites” is used to mean that the free energy of a stabilizing component molecule in the vicinity of the a surface-layer defect site is lower than the free energy of the molecule in the vicinity of a defect-free portion of the surface-layer. Examples of defects are described in more detail.

The term “vicinity” is intended to describe an area within 5 nanometers of the defect site.

As will be appreciated by those of skill in the art, the choice of stabilizing component, and the moieties which make up the solvent-philic and surface-layer-philic portions thereof, will be determined in part by the nature of the surface-layer and solvent being utilized in a particular embodiment. In view of the teachings and disclosure contained herein and given the level of skill in the art, it will be within the means of those in the art to select one or more suitable stabilizing components based on the particular surface-layer and solvent combination in use for the stabilizing solution without undue experimentation.

As disclosed herein, stabilized systems can be achieved using the stabilizing solutions described herein in conjunction with solid support/surface-layer systems. Additionally provided herein are kits including the stabilizing solution for the stabilization of a wide variety of systems, for use in combination with systems known to those of skill in the art, such as in the detection of small molecules, antibodies, proteins, thiol-modified DNA, or other molecules of interest (e.g., including biomolecules, inorganic species, organic species). See for example: “Fabrication and Imaging of Nanometer-Sized Protein Patterns” Wadu-Mesthrige, K.; Xu, S.; Amro, N. A.; Liu, G.-Y.; Langmuir, 1999, 15, 8580-8583; “Immobilization of Proteins on Self-Assembled monolayers”, Wadu-Mesthrige, K.; Amro, N. A.; Liu, G.-Y. Scanning, 2000, 22, 380-388. “Fabrication of Nanometer-Sized Protein Patterns Using atomic Force Microscopy and Selective Immobilization”, Wadu-Mesthrige, K.; Amro, N. A.; Garno, J. C.; Liu, G.-Y.; Biophysical J., 2001, 80, 1891-1899. “Positioning Proteins on Surfaces: A Nanoengineering Approach to supramolecular Chemistry”, Liu, G.-Y.; Amro, N. A. Proceeding National Academy of Science 2002, 99, 5165-5170; “Production of Nanostructures of DNA on Surfaces”, Liu, M.; Amro, N. A.; Chow, C. S.; Liu, G.-Y.; Nano Lett. 2002; 2(8); 863-867).

Examples of general types of molecules that may be used in stabilizing components include but are not limited to surfactants and amphiphiles. Molecules that may be used in stabilizing components also include molecules known to those of skill in the art which act to decrease the surface tension between the solvent and the surface-layer of the stabilized systems described herein. Molecules that may be used in stabilizing components also include molecules which preferentially associate at the defect sites of a surface-layer. As described in the background, the lack of effective methods of stabilization and the lack of compositions for use in the stabilization of stabilized systems, has slowed the development of real-world application of the systems described herein. Surprisingly, the relatively simple stabilizing solutions disclosed herein have the ability to stabilize these systems during storage and use of the systems over periods of time and do not require specialized skills or costly materials to implement.

The stabilizing component may include amphiphilic molecules and in one version the amphiphilic molecules is a molecule of the general formula R¹CONR²R³
where:
   R¹ may be, independently, —H, —OH, —NH₂, —NHOH, or —COOH;
   R² may be, independently, —H, or a C₁-C₅ branched or straight chain alkyl (e.g., C₁-C₃ alkyl, methyl, ethyl, propyl, isopropyl, etc.), aryl, or other hydrophobic moiety (e.g., —CF₃, etc.);
   R³ may be, independently, C₁-C₅ branched or straight chain alkyl (e.g., C₁-C₃, alkylmethyl, ethyl, propyl, isopropyl, etc.), aryl, or other hydrophobic moiety (e.g., —CF₃, etc.),
where at least one of R² or R³ is a hydrophobic group.

Examples of such suitable stabilizing components include, but are not limited to: N-methylformamide (NMF), N-methylacetamide (NMA), N,N-dimethylacetamide (DMA), DMF or a combination thereof. In another version, an amphiphilic molecule is DMSO. As described herein, DMSO, alone, or in combination with one or more of the stabilizing components of the formula R¹CONR²R³ may also be used in the methods, compositions and kits described herein a stabilizing component. In certain embodiments, DMF, DMSO or combinations thereof are of particular use, especially where the solvent includes water, a mixture of water and other solvents, e.g., organic solvents, or where the water forms part of a buffer system.

In other embodiments, the stabilizing component contains molecules of the formula AB, wherein, A is a solvent-philic moiety; and, Bₙ is a surface-philic moiety, where n may be, independently, 1, 2 or 3, and each B may be the same or different. In particular embodiments, A contains an amide, —OH, ether, ester, amine, or sulfoxide; and, each B is, independently, a straight or branched alkyl group or aryl group. In particular embodiments, A is a formamide, a sulfoxide, or an acetamide. Alkyl and aryl groups are as described herein. In some embodiments, A may be a molecule containing a formamide, a sulfoxide, or an acetamide.

In other embodiments, the stabilizing component may contain N,N-dimethylformamide, dimethyl sulfoxide, N,N-dimethylacetamide, N-methylformamide, or a mixture of two or more thereof.

Solvents

As used herein, the term “solvent” is used to refer generally to any fluid medium that can be contacted with at least a portion of the surface-layer.

In certain embodiments, the surface-layer will be immersed in the stabilizing solution. In other embodiments, at least portions of, or all of, both the surface-layer and solid support will be immersed in the stabilizing solution.

Suitable solvents include but are not limited to water, aqueous (e.g., aqueous buffer or an aqueous mixture of solvents), organic (for example, C₅-C₂₀ alkanes), protic, aprotic solvents, non-polar (e.g., alkane, decalin, dichloromethane), polar (e.g., chloroform) solvents or mixtures of two or more thereof. In certain embodiments, two or three solvents are used as a mixture of solvents. Examples of solvents that may be used include but are not limited to water, alcohols (e.g., C₁-C₁₅ alcohols, for example, methanol, ethanol, 2-butanol (sec butanol)octanol), hexane, or decalin. For example, a water/alcohol mixture may be used as the solvent.

Well known and/or commercially available aqueous buffers (e.g., phosphate buffered saline, etc.) may be used with the systems, kits and methods as described herein. As will be appreciated by those of skill in the art, the choice of buffer, or other solvent system, must be compatible with the use and storage of the system. For example, where biomolecules are to be used, the solvent (e.g., buffer, etc.) and other components must be suitable for the particular system in use (e.g., denaturing vs. non-denaturing conditions). In some embodiments, the solvent is water.

The stabilizing solution is made up of at least a solvent and a stabilizing component, and can optionally include other components. In certain embodiments, the solvent (including mixtures of solvents) may also include minor components of non-reactive additives with a concentration of less than 15% mole fraction. Examples of non-reactive additives include salts and other components of buffers.

For any composition used as a stabilizing solution, it will usually be straightforward to identify the solvent and stabilizing component. Generally, however, any component in a stabilizing solution can be identified as the “solvent” or “stabilizing component”, so long as the such individual component meets the requirements for being a solvent or a stabilizing component as such terms are defined herein. In general, for a two component stabilizing solution the “stabilizing component”, would be considered the component which either has a solvent-philic and a surface-layer-philic portion or that preferentially associates with defect sites on the surface-layer. The solvent would thus be considered the remaining component. The solvent and the stabilizing component are not made of the same molecules; that is, the stabilizing solution cannot be a pure solution made of only one type of molecule.

As will be apparent to those of skill in the art, it may be preferable for solvents not to interact with the surface-layer or solid support components in such a way as to initiate, cause or enhance the desorption, degradation or erosion of the surface-layer from the solid support, it may also be preferable for the solvent not to adversely effect (e.g., corrode, scar, etc.) the surface of the solid support.

As used herein, the term “solvent” for use in the stabilizing solution should be considered to include a single solvent, as well as a mixture of solvents, including those disclosed herein.

As will be apparent to those of skill in the art, the choice of solvent is dependent both upon the nature of the stabilizing component and the surface-layer. In view of the teachings herein, such selection can be made by those of skill without undue experimentation. In certain embodiments in which the stabilizing component is a fluid when in pure form, the solvent and stabilizing component will be miscible over all concentrations. In other embodiments, the solvent and stabilizing component may be miscible in the concentration range of about 1%-50%, equal to or less than 45%, about less than 40%, about less than 30%, equal to or less than about 25%, equal to or less than about 20%, equal to or less than about 15%, equal to or less than about 10%, equal to or less than about 8%, equal to or less than about 5% of stabilizing component by volume. In some embodiments, the stabilizing component and solvent will be miscible at concentrations of stabilizing component from about 1% to about 5%, from about 1% to about 8%, from about 1% to about 10%, from about 1% to about 15%, or from about 3% to about 10%, by volume.

Characterization of Stabilizing Solution

The stabilizing solution selected may depend on the system which is to be stabilized. As will be appreciated by those of skill, the amount of stabilizing component in the stabilizing solution may also depend on a number of variables as well as the particular system in use, for example, the conditions and/or requirements of use and/or storage of the system, e.g., short, medium or long-term shelf life, uses requiring vigorous or extended periods of stirring or agitation, temperature of storage and/or use, exposure to light and/or other forms of radiation, pH of the solvent (if aqueous), variation of pH, need for aggressive washing during use, etc. Those of skill in the art should be able to adjust the amount of stabilizing component in the stabilizing solution to achieve stabilization of particular systems according to the requirements of use and/or storage in view of the teachings disclosed herein, incorporated by reference, and knowledge of the state of the art.

As used herein, the term “amount of stabilizing component” refers to the amount of stabilizing component (including combinations of stabilizing components) in the stabilizing solution by volume.

In some embodiments, the amount of the stabilizing component will be in the concentration range of about 0.01%-65%, equal to or less than 65%, equal to or less than 60%, equal to or less than 55%, equal to or less than 50%, equal to or less than 45%, equal to or less than 40%, equal to or less than 35%, equal to or less than 30%, equal to or less than about 25%, equal to or less than about 20%, equal to or less than about 15%, equal to or less than about 10%, equal to or less than about 8%, equal to or less than about 5%, of stabilizing component by volume. In some embodiments, the concentration of stabilizing component may be from about 0.01% to about 5%, from about 2% to about 8%, from about 4% to about 7%, from about 0.01% to about 10%, from about 0.01% to about 15%, from about 0.05% to about 10%, from about 0.04% to about 11%, from about 0.1% to about 15%, from about 1% to about 15%, from about 0.01% to about 20%, or from about 3% to about 10%, by volume.

The term “stabilized”, including variations thereof (e.g., increased stability, stabilizing, etc.), is used herein to refer to systems which show, or stabilizing solutions or components which promote, the inhibition, slowing, elimination, or other regulation of the degradation of the surface-layer from the surface of the solid support, and therefore reduce or eliminate the appearance of degradations of the surface layer over a given period of time and/or under certain conditions of use and/or storage (e.g., variations in temperature, vigorous or extended stirring, variations in pH, aggressive washing, exposure to light and/or other forms of radiation, etc.).

The amount of stabilization may be quantified by a variety of measurements including but not limited to comparisons of the degradation in the stabilized system versus degradation in a solid support/surface-layer system (reference system) in the presence of solvent but without stabilizing component, or versus degradations in a solid support/surface-layer system under conditions of UHV. Measurement and comparison of the degradations of the stabilized and reference systems can be carried out using the AFM and STM protocols and analysis as disclosed herein, particularly as described in detail in the Examples, or using other techniques and analyses known to those of skill in the art, such as x-ray photoelectron spectroscopy, infrared and Raman spectroscopy, electrochemistry, ellipisometry, quartz crystal microbalance, radiolabeling, etc.

Generally, a system may be described as stabilized if it shows any amount of stabilization over any timeframe versus a reference system.

The amount of stabilization at a given time may be quantified in a variety of ways including but not limited to the percentage of the surface-layer retaining its original morphology after the given time has elapsed. For example, a SAM that is perfect at time zero but becomes 30% disordered or for which 30% of the SAM desorbs after 24 hours could be characterized as having a stability of 70% after 24 hours. Other possible quantifications will be apparent to those skilled in this technology.

In certain embodiments, the period of measurement for stabilization will be about 1 hour, about 3 hours, about 5 hours, about 8 hours, about 12 hours, about 18 hours, about 24 hours, about 36 hours, about 48 hours, about 72 hours, about 100 hours, about 150 hours, about 1 week, about 10 days, about 2 weeks, about 1 month, about 45 days, about 2 months, about 3 months, about 6 months, about 8 months, about 12 months, or about 18 months.

In particular embodiments, the stabilized system will show stabilization relative to a reference system for at least about 1 hour, about 3 hours, about 5 hours, about 8 hours, about 12 hours, about 18 hours, about 24 hours, about 36 hours, about 48 hours, about 72 hours, about 100 hours, about 150 hours, about 1 week, about 10 days, about 2 weeks, about 1 month, about 45 days, about 2 months, about 3 months, about 6 months, about 8 months, about 12 months, about 18 months, or 2 years.

Mechanisms for Degradation of Surface-Layers and Methods of Stabilizing Solid Support/Surface-Layer Systems

Using STM and AFM, in situ and time-dependent imaging reveals and confirms that degradations (including that produced by both desorption and oxidation/desorption processes) of a surface-layer bonded to a surface of a solid support initiate mainly at defect sites, such as domain boundaries, grain boundaries, vacancy islands, and other defect sites (e.g., holes, pits, cracks, dislocations, island edges, step edges, etc. or combinations of two or more of the foregoing), and then propagate into the ordered domains.

Without being bound by theory, it is believed that an effective means to prevent or retard these degradations is by contacting the surface-layer with a stabilizing solution that includes a stabilizing component that preferentially associates with defect sites in the surface-layer. An example of such a stabilizing solution is DMF or DMSO in water which may be used to stabilize an alkylthiol SAM bonded to a gold surface, and it is which it is believed that the DMF or DMSO molecules preferentially associate with defect sites in the alkylthiol SAM.

The effect of the stabilizing solutions described herein has been measured, as described in the Examples, using high-resolution studies which demonstrate that the stabilizing components of the stabilizing solution (e.g., DMSO or DMF in water) appear to attach to SAM surfaces more favorably at defect sites. The adhesions to defect sites are relatively more stable than those of the ordered domains, as these adsorbates sustain long time stirring and STM imaging. While not wishing to be bound by theory, it appears that the stabilization of SAMs by DMF (or DMSO) in water arises from the interactions of DMF with SAMs and water molecules. The hydrophobic portions of the DMF, e.g. the two methyl groups, associate preferentially with the surface-layer at the methyl termini of the ordered domains and to chains at defect sites, while the hydrophilic portion of the DMF forms stable H-bonds with water molecules. It appears that the stabilization of SAMs increases the activation energy barrier, thus inhibiting desorption processes. A quantitative analysis of desorption kinetics and dynamics in various media suggests that adding DMSO and DMF in water can increase the activation energy by 10-15 kJ/mol. Such an estimation appears to be supported by experimental results of SAM desorption at room and elevated temperatures.

Applications of Stabilized Systems and Kits

As described above, there has been a long felt need for stabilized systems, and methods and compositions capable of stabilizing systems already developed.

The stabilizing solutions described herein can be used to stabilize a variety of systems, including but not limited to stabilization of surface-layers used as resists, sensors (e.g., of biomolecules or other molecules of interest, etc.), cantilevers, etc. Additional exemplary applications include, for example, stabilization of surface-layers used as resists for microfabrication and nanofabrication, and substrates including DNA and protein micro- and nano-array, biosensing, immunoassay diagnostics, DNA probe diagnostics and sequencing, pharmacological and toxicological testing, and cell growth studies. It is intended that the kits described herein may be used in any of the applications of the stabilized systems or stabilized surface-layers as described herein, and, further, these kits can be used in the preparation of the stabilized systems and stabilized surface-layers described herein, or, in the performance of the methods as described herein.

Also described herein are kits that can be used for stabilizing solid support/surface-layer systems. Such kits will include a stabilizing solution, instructions, and other optional components. The stabilizing solution will include a solvent and a stabilizing component which can be any of the solvents and stabilizing components described herein. The instructions will generally instruct how to use the stabilizing solution for stabilizing a solid support/surface-layer system.

The invention is further illustrated by the following non-limiting examples.

### EXAMPLES

Unless otherwise noted, the materials used in the Examples are as listed under “Materials” below. SAMs are prepared as described in Example 1, unless otherwise noted. AFM and STM studies, unless indicated otherwise, are carried out according to the procedures and on the instruments described in Examples 2 and 3, including the protocols and analyses incorporated by reference herein.

### Materials

The compounds 1-decanethiol, (HS(CH₂)₉CH₃, 96% purity); 1-octadecanethiol, (HS(CH₂)₁₇CH₃, 96% purity); 1-hexanethiol, (HS(CH₂)₅CH₃, 95% purity); 1-dodecanethiol, (HS(CH₂)₁₁CH3, 96% purity), mercapto 1-undecanol (HS(CH₂)₁₁OH, 97% purity); 1,9-nonanedithiol (HS(CH₂)₉SH, 95% purity); and 16-mercapto-1-hexadecanoic acid (HS(CH₂)₁₅COOH, 90% purity) were purchased from Aldrich (St. Louis, Mo.) without further purification. Pyridinium dichromate (PDC, C₁₀H₁₀N₂.H₂Cr₂O₇, 98% purity) and 3-mercapto-1-propanol, (HS(CH₂)₂CH₂OH, 95% purity) were also purchased from Aldrich (St. Louis, Mo.). The compounds mercapto-propanal and mercapto-undecanal (HS(CH₂)₂CHO and HS(CH₂)₁₀CHO, respectively), were synthesized according to the following procedure:

(1) Mercapto undecanal, HS(CH₂)₁₀CHO, was synthesized by the oxidation of mercapto undecanol, HS(CH₂)₁₀CH₂OH, with pyridinium dichromate, (PDC). A 0.5 g portion of HS(CH₂)₁₀CH₂OH (2.45 mM) was dissolved in CH₂Cl₂, then 1.38 g of PDC (3.67 mM) was added. The mixture was allowed stir at room temperature for 18 h. At the completion of the reaction as indicated by TLC analysis, the mixture was diluted with CH₂Cl₂ and filtered through a thin pad of celite. The filtrate was eluted through a silica gel chromatography column to obtain 0.24 g (1.13 mmols, 48% yield) of HS(CH₂)₁₀CHO as a white solid. ¹H NMR (300 MHz, CDCl₃) δ1.27 (broad s, 12H) 1.63 (m, 4H), 2.41 (m, 2H), 2.66 (t, J=7.2 Hz, 2H) 9.8 (s, 1H); ¹³C NMR (125 MHz, CDCl₃) δ822.0, 28.5, 29.1, 29.2, 29.3, 29.4, 39.1, 43.9, 202.9.

(2) Mercapto propanal, HS(CH₂)₂CHO, was synthesized by the oxidation of mercapto propanol, HS(CH₂)₂CH₂OH, with pyridinium dichromate, (PDC). A 1.0 mL volume of HS(CH₂)₂CH₂OH was dissolved in CH₂Cl₂. After dissolution, 2.18 g of PDC (4.12 mM) was added. The mixture was allowed to stir at room temperature for 18 hours under nitrogen. At completion of the reaction as indicated by TLC analysis, the mixture was diluted with CH₂Cl₂ and filtered through a thin pad of celite. The filtrate was purified using silica gel column chromatography to obtain 0.8 mL of HS(CH₂)₂CHO as a transparent liquid. ¹H NMR (300 MHz, CDCl₃) δ 2.41 (m, 2H) 2.66 (t, J=7.2 Hz, 2H), 9.8 (s, 1H); ³C NMR (125 MHz, CDCl₃) δ 6.70, 37.93, 203.9.

Solvents N,N-dimethylformamide (DMF, Aldrich), dimethyl sulfoxide (Aldrich), sec-butanol (Aldrich), dichloromethane (CH₂Cl₂, 99.9% purity, HPLC grade, Aldrich), hexane (Fisher Scientific), ethanol (Fisher Scientific) were used as received. 10× phosphate buffered saline (PBS) buffer solutions (EM Science) were diluted 10 times before usage. Deionized water was purified with a Millipore-Q system with a resistivity of 18 MΩ cm.

Rabbit immunoglobulin G (IgG, purity 95%), and mouse anti-rabbit IgG were purchased from Sigma Biochemicals, (St. Louis, Mo.) and used as received. Phosphate buffered solution (PBS, pH 7.2), and Tween 20® ((Polyoxyethylene(20)sorbitan monolaurate) for molecular biology viscous liquid) were purchased from Sigma Biochemicals, (St. Louis, Mo.). Thiolated biotin was obtained from (ProChimia, Poland).

### Example 1

### Preparation of Self-Assembled Monolayers

Gold (Alfa Aesar, 99.99%, Ward Hill, Mass.) was deposited in a high-vacuum evaporator (Denton Vacuum Inc., Moorestown, N.J., model DV502-A) at 2×10⁻⁷ Torr onto mica substrates (clear ruby muscovite mica, S&J Trading Co., NY). The mica was freshly cleaved immediately before being mounted on the substrate holder inside the vacuum chamber. The evaporation rate was 3.0 Å/s, and the mica substrate was maintained at 625 K during Au deposition. After evaporation, films were annealed at 625 K for 20 minutes to yield relatively large Au(111) terraces, 100 to 200 nm in lateral dimension according to our scanning tunneling microscopy (STM) (Yang, G., Liu, G. Y. J. Phys. Chem. B 2003, 107, 8746-8759; Qian, Y., Yang, G., Yu, J. J., Jung, T. A., Liu, G. Y. Langmuir 2003, 19, 6056-6065) and atomic force microscopy (AFM) measurements (Xu, S., Laibinis, P. E., Liu, G. Y. J. Am. Chem. Soc. 1998, 120, 9356-9361; Xu, S., Cruchon-Dupeyrat, S. J. N., Garno, J. C., Liu, G. Y., Jennings, G. K., Yong, T. H., Laibinis, P. E. J. Chem. Phys. 1998, 108, 5002-5012; Xu, S., Cruchon-Dupeyrat, S. J. N., Garno, J. C., Liu, G. Y., Jennings, G. K., Yong, T. H., Laibinis, P. E. J. Chem. Phys. 1998, 108, 5012).

Alkanethiol SAMs were formed by soaking gold thin films (immediately after vacuum deposition or peeling) in 1 mM ethanolic solutions of alkanethiol. Each gold substrate remained in a thiol solution for 2-7 days at room temperature to ensure the formation of mature monolayers with high coverage and a low density of defects. The preformed SAMs were rinsed with ethanol and dried in air for less than 5 minutes prior to soaking in solvents. All immersion experiments in solvents were performed at room temperature, unless otherwise specified.

### Example 2

### Atomic Force Microscopy (AFM)

The atomic force microscope used for this study incorporates a home-constructed, deflection-type scanner controlled by commercial STM 1000 electronics controller and software (RHK Technology, Inc., Troy, Mich.). The setup allows simultaneous acquisition of multiple images such as topography, frictional force and elasticity images. The scanner can be operated under ambient laboratory conditions, or in liquid media (Kolbe, W. F., Ogletree, D. F., Salmeron, M. B. Ultramicroscopy 1992, 42, 1113-1117; Liu, G. Y., Fenter, P., Chidsey, C. E. D., Ogletree, D. F., Eisenberger, P., Salmeron, M. J. Chem. Phys. 1994, 101, 4301-4306). The cantilevers-made of Si₃N₄ were sharpened microlevers (Veeco Metrology Group, Santa Barbara, Calif.) with a force constant of 0.1 N/m. Images were acquired with a typical force of 0.1 nN using contact mode in liquid media.

### Example 3

### Scanning Tunneling Microscopy (STM)

The scanning tunneling microscope used for these studies incorporated a walker type configuration scanner (UHV 300 VT STM, RHK Technology, Inc. Troy, Mich.) (Yang, G., Liu, G. Y. J. Phys. Chem. B 2003, 107, 8746-8759; Qian, Y., Yang, G., Yu, J. J., Jung, T. A., Liu, G. Y. Langmuir 2003, 19, 6056-6065). The STM tips used for these studies were tungsten wires cut under ambient condition, and then electrochemically etched in a 3M KOH solution at 2.1 V. A homemade electrochemical potentiostat was used to automatically monitor and stop the etching process when the current dropped below the setpoint (Yang, G., Liu, G. Y. J. Phys. Chem. B 2003, 107, 8746-8759; Qian, Y., Yang, G., Yu, J. J., Jung, T. A., Liu, G. Y. Langmuir 2003, 19, 6056-6065). STM piezoelectric scanners were calibrated laterally with the periodicity of graphite(0001), and vertically using the height of Au(111) steps (2.35 Å). Calibrations were further verified by the periodicity of decanethiol SAMs on Au(111). All images reported in this work were acquired in high-impedance, constant current mode under ambient conditions within one hour. Similar structures and morphologies of SAMs on gold were observed both in UHV and air. The typical tunneling current was set at 30 pA, and the bias voltage of 1 V.

### Example 4

### Desorption Kinetics and Mechanisms of Alkanethiol SAMs

It has been reported that when immersed in solvents, the adsorbed thiols within a SAM spontaneously desorb (Schlenoff, J. B., Li, M., Ly, H. J. Am. Chem. Soc. 1995, 117, 12528-12536). The desorption process of SAMs was monitored as described herein using AFM in various solvents including water, ethanol, 2-butanol, hexane, and decalin, according to the techniques described in Schlenoff et al. 1995 (ibid).

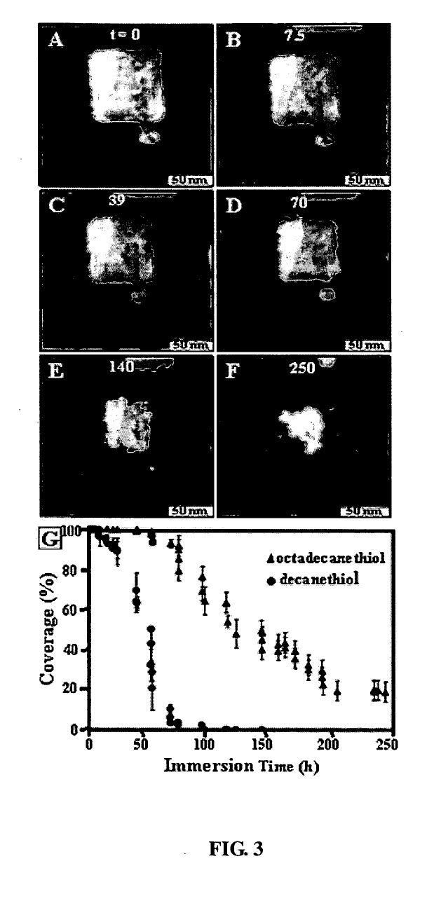

FIG. 3 shows six snapshots selected from time-dependent AFM imaging of SAMs in 2-butanol. Two nanostructures of octadecanethiol islands within a decanethiol matrix were produced prior to the kinetics study as described in: Liu, G. Y., Xu, S., Qian, Y. L. Acc. Chem. Res. 2000, 33, 457-466; Xu, S., Miller, S., Laibinis, P. E., Liu, G. Y. Langmuir 1999, 15, 7244-7251; Xu, S., Liu, G. Y. Langmuir 1997, 13,127-129. The edges of the nanostructures mimic an engineered domain boundary, and these nanostructures also served as landmarks for in situ imaging. Immediately after the fabrication, the thiol solution was replaced by pure 2-butanol and the desorption process was continuously monitored. During the first 4 h of immersion, the AFM images showed little change in surface topography. After 7.5 h (FIG. 3B), the matrix decanethiol SAM began to desorb, resulting in the appearance of many dark areas that were 1.1 nm deep and 20-200 nm in lateral dimensions. After 39 h (FIG. 3C), 50% of the decanethiol matrix thiol molecules detached, while the octadecanethiol patterns remained unchanged.

Some changes in the octadecanethiol nanopatterns occurred after 70 h of immersion in 2-butanol. As shown in FIG. 3D, the octadecanethiol molecules began to desorb from the edges of the smaller pattern and the line connecting the two patterns. Since desorption occurs primarily from the edges, smaller domains are more susceptible to the desorption processes than larger ones. In contrast to the octadecanethiol nanopatterns, 90% of the surrounding decanethiol layer had desorbed during this time, as evidenced by the dark areas in FIG. 3D. High-resolution AFM images revealed the periodicity of Au(111) in these dark areas, confirming the desorption of the matrix SAM. Subsequent desorption of octadecanethiol molecules continued from the edges of the patterns (FIGS. 3E and F), and approximately 50% and 30% of the original octadecanethiol island remained attached to the gold substrate after immersion for 140 h and 250 h, respectively.

FIG. 3G shows a plot of the surface coverage of the patterned and matrix SAMs extracted from the time-dependent AFM studies. Clearly, the octadecanethiol nanopatterns were more stable than the surrounding C₁₀S SAM in 2-butanol. First-order plots of decanethiol and octadecathiol desorption from gold in 2-butanol yield rate constants of 4×10⁻⁶ s⁻¹ and 1.5×10⁻⁶ s⁻¹, respectively. The first-order rate constants for desorption of octanethiol on gold in tertrahydrofurane (THF) was reported to be 2.1×10⁻⁵ s⁻¹, which is one order of magnitude higher than measurements from the AFM study (Schlenoff, J. B., Li, M., Ly, H. J. Am. Chem. Soc. 1995, 117, 12528-12536). The difference may originate from the fact that AFM measures the local coverage of the standing-up thiol molecules, as opposed to radiolabeled (³⁵S) octadecanethiol measurements (Schlenoff, J. B., Li, M., Ly, H. J. Am. Chem. Soc. 1995, 117, 12528-12536), which monitor scintillation counting of the surface. The measured coverage versus time curves provided a guide for determination of the time frame and reaction conditions in the subsequent treatments.

### Example 5

### Molecular-Level Imaging of Monolayer Degradation

To gain molecular insight regarding the degradation mechanism, STM was used to visualize the resulting SAMs after the exposure to different conditions. Alkanethiol SAMs on gold with saturation coverage were characterized extensively by STM with molecular-level resolution according to the techniques in: Yang, G., Liu, G. Y. J. Phys. Chem. B 2003, 107, 8746-8759; Poirier, G. E. Chem. Rev. 1997, 97, 1117-1127; Delamarche, E., Michel, B., Biebuyck, H. A., Gerber, C. Adv. Mater. 1996, 8, 719.

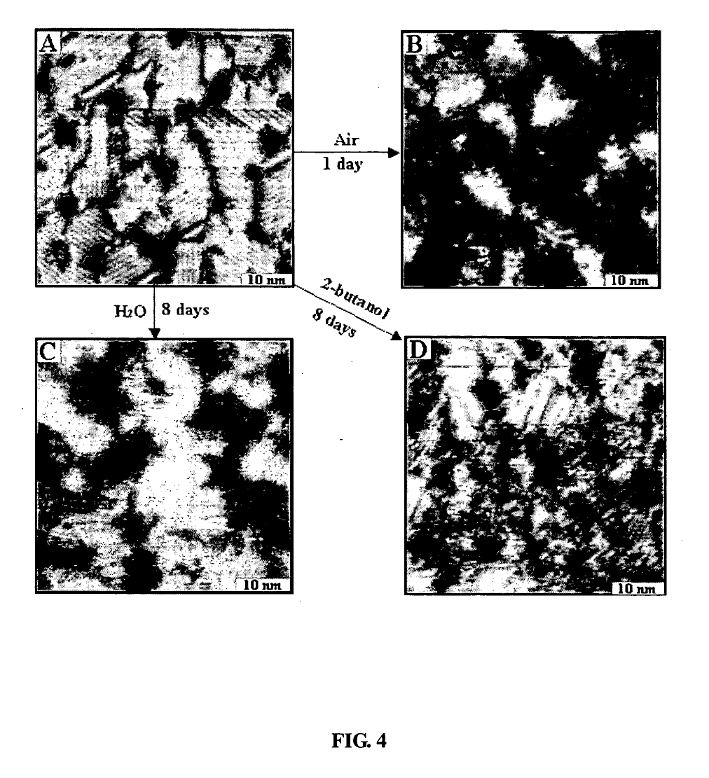

A typical high-resolution STM topographic image of a freshly prepared SAM on Au(111) is shown in FIG. 4A (50×50 nm² area). Well-ordered domains ranging from 5 to 20 nm with various orientations with c(4√3×2√3)R30° superstructures were clearly visible (Poirier, G. E. Chem. Rev. 1997, 97, 1117-1127; Poirier, G. E., Tarlov, M. J. Langmuir 1994, 10, 2853-2856; Delamarche, E., Michel, B., Gerber, C., Anselmetti, D., Guntherodt, H. J., Wolf, H., Ringsdorf, H. Langmuir 1994, 10, 2869-2871). These ordered domains were separated by domain boundary networks (dark depression lines) and vacancy islands (dark pits, 0.235 nm in depth) (Yang, G., Liu, G. Y. J. Phys. Chem. B 2003, 107, 8746-8759; Poirier, G. E. Chem. Rev. 1997, 97, 1117-1127; Poirier, G. E. Langmuir 1997, 13, 2019-2026). All STM images in FIG. 4 were acquired after sequentially washing the samples with ethanol, hexane, and ethanol. Continuous exposure under ambient laboratory conditions resulted in a broadening of domain boundaries, and a significant fraction (more than 60% of the surface for 1-day exposure) of the ordered domains degraded to a disordered structure around vacancy islands, as revealed in FIG. 4B.

It is believed that the structural changes from FIG. 4A to 4B are due to oxidized thiol molecules being washed away prior to imaging. From the observation that oxidation of surfaces results in the broadening of domain boundaries and the formation of disordered structures around vacancy islands, it is inferred that these defects were the preferred sites for oxidation followed by detachment (Poirier, G. E., Herne, T. M., Miller, C. C., Tarlov, M. J. J. Am. Chem. Soc. 1999, 121, 9703-9711).

Soaking of the monolayer in liquid media resulted in gradual desorption of thiol molecules. In pure water, only a small fraction (less than 20%) of decanethiol desorbed over the course of a week, consistent with a previously published spectroscopy study (Schlenoff, J. B., Li, M., Ly, H. J. Am. Chem. Soc. 1995, 117, 12528-12536). After an 8-day immersion in pure water, a 25-30% decrease in coverage was observed, where wider dark areas between ordered domains and around vacancy islands are evident in FIG. 4C. These dark areas correspond to the desorbed, disordered low coverage structures.

Soaking in organic solvents such as pure 2-butanol for 8 days led to significant desorption (50-60%), as shown in FIG. 4D. It is believed that the higher degree of degradation or faster desorption kinetics in organic solvents arises from the higher solubility of thiols in organic solvents than in water, which stabilizes the products. The solvation of thiols results in lowering the free energy of transition states, thus lowering the activation barrier. The formation of disordered phases can be readily observed in organic solvents, and disordered phases mainly appeared at domain boundaries and around the vacancy islands. The location of disordered phases arises from the fact that solvent molecules solvate thiols much more easily at the defect sites and domain boundaries, initiating desorption. This desorption mechanism, i.e. initiating and propagating via defect sites, is also supported by the observation that exchange reactions of SAMs were also initiated at domain boundaries and around vacancy islands, Lin, P. H., Guyot-Sionnest, P. Langmuir 1999, 15, 6825-6828; Dunbar, T. D., Cygan, M. T., Bumm, L. A., McCarty, G. S., Burgin, T. P., Reinerth, W. A., Jones, L., Jackiw, J. J., Tour, J. M., Weiss, P. S., Allara, D. L. J. Phys. Chem. B 2000, 104, 4880-4893.

### Example 6

### Desorption Inhibition and Regulation

Molecular level information on desorption mechanisms and kinetics provided insight into protocols designed to inhibit and regulate degradation of monolayers. Two important observations were re-emphasized: (1) SAM desorption in water exhibited the slowest kinetics among all solvents tested or reported; (2) desorption and oxidation initiate at defect sites, such as domain boundaries and vacancy islands. To inhibit or regulate desorption processes aqueous solutions with small amount of stabilizing agent molecules that had strong affinity towards defect sites were used. DMF and DMSO were found to be the best candidates. Molecular structures of DMF and DMSO have unique features. While the hydrophilic groups ensure the hydrogen-bond formation with water, the hydrophobic portion exhibit strong affinity towards methyl termini and hydrocarbon chains at defect sites.

Stabilization of Nanostructured SAMs Using DMF in Aqueous Media.

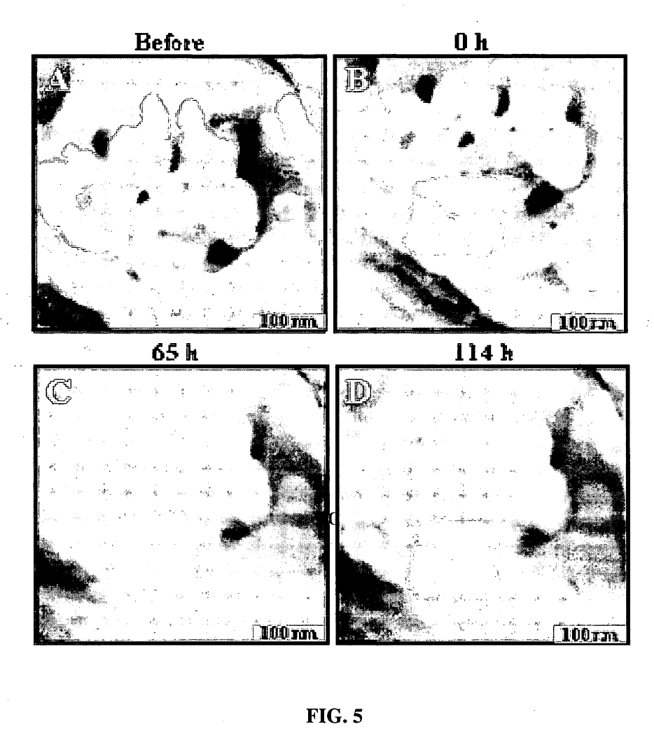

The stability of nanopatterned SAMs in a 5% DMF (by volume) in water was investigated by in situ, time-dependent AFM imaging. FIG. 5 shows four snapshots at various stages. The decanethiol matrix was imaged in aqueous solution containing 0.1 mM octadecanethiol molecules in a 5% DMF aqueous solution as shown in FIG. 5A.

The AFM topographic image shows that the SAM has a smooth surface decorated by single atomic Au(111) steps, and vacancy islands. Two nanografted patterns (Liu, G. Y., Xu, S., Qian, Y. L. Acc. Chem. Res. 2000, 33, 457-466; Xu, S., Miller, S., Laibinis, P. E., Liu, G. Y. Langmuir 1999, 15, 7244-7251; Xu, S., Liu, G. Y. Langmuir 1997, 13, 127-129), a 150×150 nm² square and 10×10 nm² island are produced within the decanethiol monolayer, which served as landmarks as well as SAMs with longer chain length. Immediately after the fabrication, the ternary mixture of octadecanethiol, DMF, and water solution was replaced by a binary mixture of 5% DMF in water. The surface evolution of the monolayers was continuously monitored. During the 114 h of immersion (total experiment time) in 5% DMF in water, the AFM images revealed no changes in surface topography, neither in the matrix nor in nanopatterns (FIGS. 5B-D).

Desorption Inhibition of SAMs using DMF and DMSO in Aqueous Media.

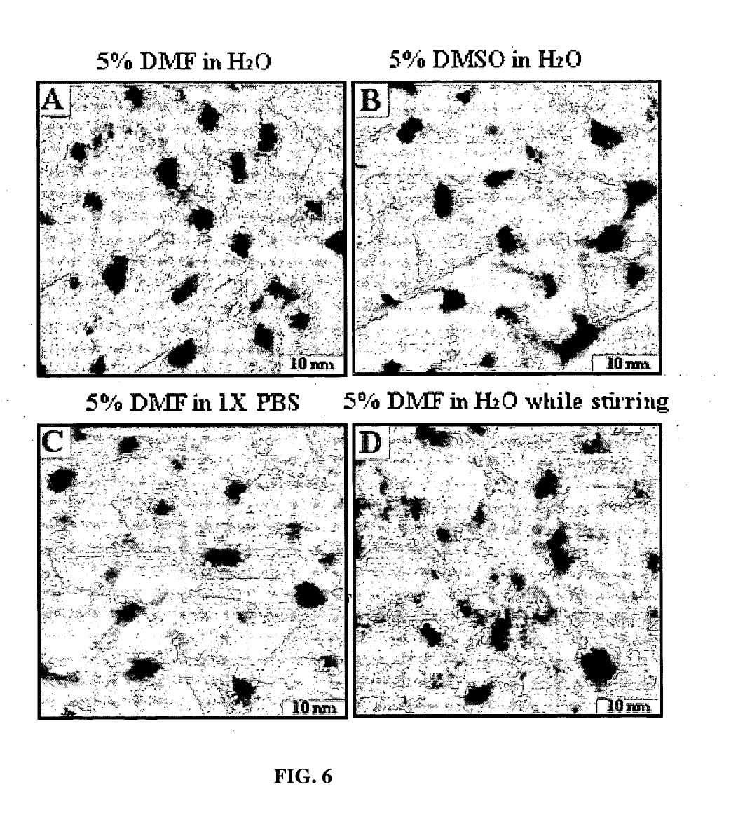

The robustness of the preserving effect of amphiphilic molecules was further demonstrated by high-resolution investigations using STM. FIGS. 6A and 6B show decanethiol SAMs after 8-day immersion in 5% DMF and 5% DMSO aqueous solutions, respectively. Both samples were washed with ethanol, hexane, and ethanol prior to imaging. The morphological similarity and the lack of degradation are evident when STM topographs shown in FIG. 6 are compared with FIG. 4A. No degradation, even at the molecular level, was ever detected in both media in the duration of our tests, i.e. up to 50 days.

The STM image in FIG. 6C was acquired after the immersion of preformed decanethiol SAMs in a 5% DMF and 1×PBS buffer mixture for 8 days (the duration of the experiment). The immersion shows little structural change at the molecular level, even in the presence of electrolytes. This observation is important for applications of SAMs in biotechnology. Constant stirring does not impact the preservation power of DMF. FIG. 6D reveals a decanethiol monolayer in 5% DMF and water after 8-day stirring in which little or no degradation was observed, which was significant as many SAM applications may require harsh conditions in laboratory storage.

### Example 7

### Regulating Desorption Kinetics

Effect of DMF Concentration

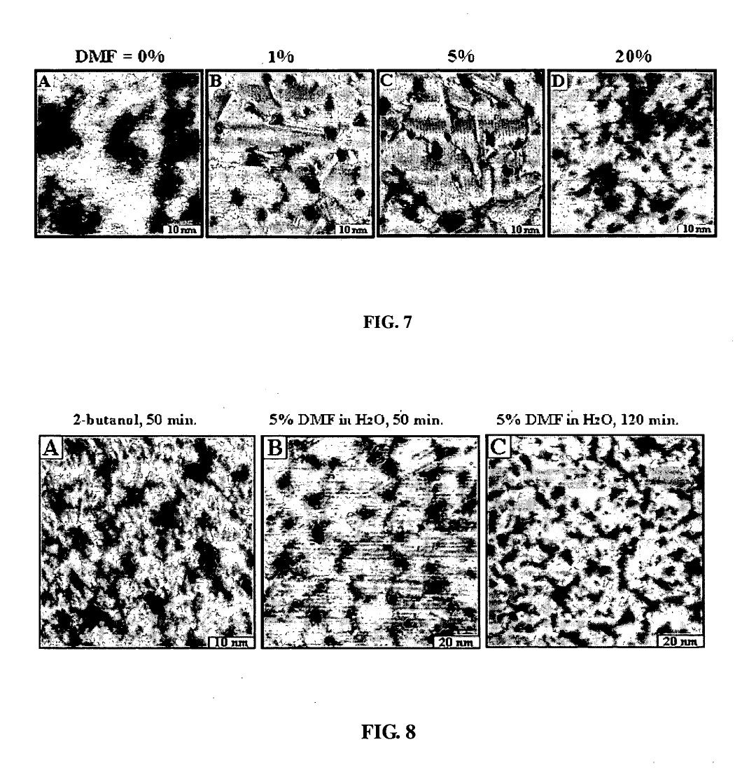

A systematic investigation of monolayer stability as a function of DMF concentrations was performed in water. STM images in FIG. 7 show surface morphologies of decanethiol SAMs on Au(111) after 45-day immersions in aqueous solutions with increasing DMF concentrations. After 45-day immersion in pure water, approximately 25-30% of decanethiols desorb from the SAM (see wider gaps between domains and around vacancy islands in FIG. 7A). Addition of 1% DMF (v/v) in water prevented SAM desorption, as shown in FIG. 7B. Increasing the concentration of DMF up to 5% resulted in optimal inhibition under these conditions. FIG. 7C was acquired after a 45-day immersion. Increasing DMF concentration above 15% started to decrease desorption inhibition ability. At 20% DMF concentration, a significant portion of molecules, up to 30%, desorbed from the surface, resulting in the formation of disordered structures surrounded by ordered (√3×√3)R30° domains (FIG. 7D).

Effect of Temperature

The influence of temperature was also examined by STM. FIG. 8A was acquired after 50-min. heating of a decanethiol SAM at 65° C. in sec-butanol. Two distinct regions, well-ordered small domains and disordered phases (approximately 50%) were identified. The linear domain boundaries disappeared upon heating. Ordered domains, ranging from 1 to 10 nm in diameter, were surrounded by the disordered phases. The small domains were formed by means of the propagation of desorption process from defect sites, such as domain boundaries and vacancy islands. After 90-min. heating, the whole surface was converted to disordered phases, where no molecular order was observed.

At room temperature, alkanethiol SAMs can be preserved in 5% DMF aqueous solutions for at least 50 days. However, less than 5% desorption occurs after 50 minutes heating at 65° C., as shown in FIG. 8B. FIG. 8B showed ordered domains of the (√3×√3)R30° structure separated by domain boundaries and vacancy islands. In contrast, almost 50% desorption was observed in 2-butanol under the same heating conditions. Prolonged immersion at elevated temperatures would eventually result in partial loss of decanethiol. FIG. 8C reveals the surface structure after 120-minute immersion at 65° C. in 5% DMF aqueous solutions. Compared to FIG. 8B, the average domain size decreased and domain boundaries broadened in FIG. 8C, corresponding to 15% desorption.

### Example 8

### Molecular Level Mechanism and Energetics

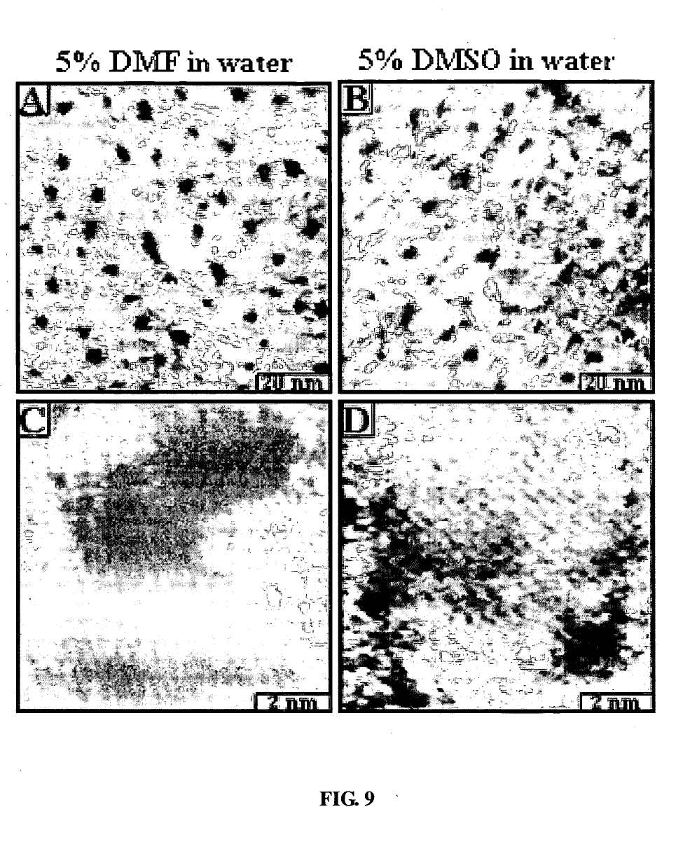

STM images acquired without aggressive washing of SAMs provided clues regarding the mechanism of desorption inhibition in DMF and DMSO aqueous solutions. In FIG. 9, the STM images were acquired after soaking a decanethiol SAM in 5% DMF and 5% DMSO in water for 45 days, respectively. In comparison to typical SAM surfaces imaged after washing, e.g., in FIGS. 4A and 6, extra bright features were present in FIGS. 9A and 9B. These features were more clearly revealed in the high resolution STM image in FIGS. 9C and 9D, where the ordered structures of SAMs were clearly resolved, and extra bright features were present at domain boundaries and around vacancy islands. These features were not present in SAMs soaked in other media regardless of washing procedures. Aggressive washing can remove most of these features, and the corresponding SAM morphology looks similar to the freshly prepared surfaces (see FIG. 6 in comparison to FIG. 4A). Therefore, these bright features were attributed to DMF or DMSO molecules attached to thiol termini and chains at and around defect sites.

### Example 9

### Molecular Dynamics Simulations

In addition to STM studies, a molecular dynamics simulation study of DMSO adsorption on SAMs from aqueous solutions was performed as suggested by the inventors. The results of these simulations have been published as Vieceli, J., Benjamin, I. Langmuir 2003, 19, 5383-5388, which is hereby incorporated by reference in its entirety.

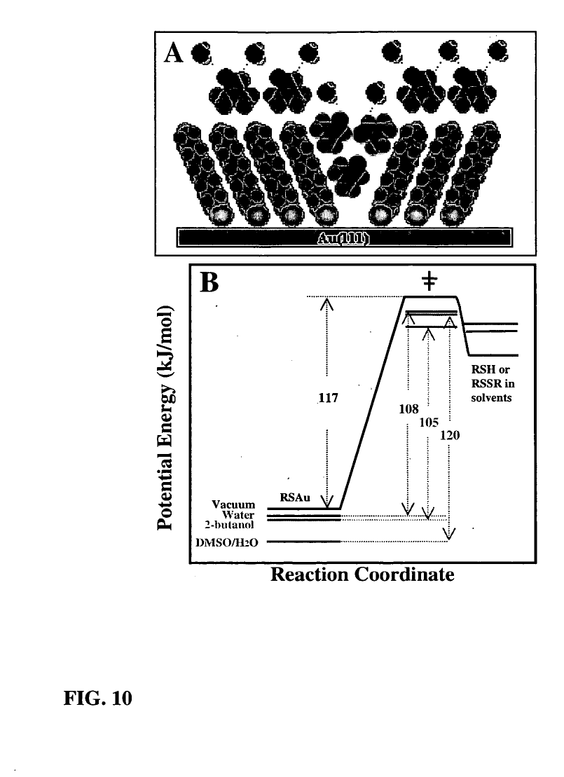

Simulation results revealed that the two methyl groups of each DMSO molecules were oriented towards the SAM termini and carbon chains in the well-ordered area and at defect sites, respectively, while the SO portion of DMSO formed hydrogen bonds with solvent water (Vieceli, J., Benjamin, I. Langmuir 2003, 19, 5383-5388). These adsorbates at interfaces are believed to significantly hinder desorption by stabilizing SAMs in water. DMF exhibits very similar molecular structure and functionalities (hydrophobic methyl groups and hydrophilic carbonyl group) as DMSO. Therefore, it has been inferred that DMF molecules adsorb onto SAM surfaces with methyl groups attaching to the methyl termini in the ordered domains and to the chains at the defect sites, while forming hydrogen bonds with water via the hydrophilic portion of DMF, as schematically shown in FIG. 10A. DMF molecules at and around defect sites exhibited higher adsorption energy than other solvent molecules and DMF molecules on ordered domains, thus sustaining the STM imaging process.

Desorption of alkanethiol SAMs from gold surfaces demonstrates that there are two distinct kinetic regimes: initial fast desorption and a final slow process (Schlenoff, J. B., Li, M., Ly, H. J. Am. Chem. Soc. 1995, 117, 12528-12536; Garg, N., Carrasquillo-Molina, E., Lee, T. R. Langmuir 2002, 18, 2717-2726). A more quantitative view is obtained by analysis of the desorption kinetics and thermodynamics during initial desorption as modeled in molecular dynamics simulations and as illustrated in FIG. 10B.

In ultrahigh vacuum, initial desorption energy (equal to the activation energy) of thiol moieties was reported to be 117 kJ/mol (Nuzzo, R. G., Zegarski, B. R., Dubois, L. H. J. Am. Chem. Soc. 1987, 109, 733-740), thus desorption is hardly observable at room temperature. This reaction pathway and energy served as a reference for thiol desorption dynamics in liquid media. On one hand, the presence of solvent molecules stabilizes reactants, i.e., SAMs, in liquid due to Van der Waals interactions. On the other hand, solvent molecules are expected to destabilize the products, and the transition state due to solvation (Jung, L. S., Campbell, C. T. J. Phys. Chem. B 2000, 104, 11168-11178). The trade-off often lowers the activation energy for desorption (Jung, L. S., Campbell, C. T. J. Phys. Chem. B 2000, 104, 11168-11178), because solvation is more effective for free thiols than for adsorbed thiols. Due to the lack of precise solvation energy of alkanethiol in different solvents, the activation barrier was normally estimated from kinetics measurements in the initial desorption process. Assuming a first-order initial desorption (Schlenoff, J. B., Li, M., Ly, H. J. Am. Chem. Soc. 1995, 117, 12528-12536), the rate constants were calculated to be 2×10⁻⁶ s⁻¹ and 4×10⁻⁶ s⁻¹ for SAM desorption in pure water (Schlenoff, J. B., Li, M., Ly, H. J. Am. Chem. Soc. 1995, 117, 12528-12536) and 2-butanol, respectively. Assuming a pre-exponential factor (Bain, C. D., Troughton, E. B., Tao, Y. T., Evall, J., Whitesides, G. M., Nuzzo, R. G. J. Am. Chem. Soc. 1989, 111, 321-335; Nuzzo, R. G., Zegarski, B. R., Dubois, L. H. J. Am. Chem. Soc. 1987, 109, 733-740; Lavrich, D. J., Wetterer, S. M., Bernasek, S. L., Scoles, G. J. Phys. Chem. B 1998, 102, 3456-3465) of 10¹³ s⁻¹, a simple Arrhenius-like relationship yielded activation energies of 108 and 105 kJ/mol in water and sec-butanol, respectively. As a validation of such estimations, the activation energies of desorption in decalin was measured to be 109 kJ/mol for hexadecanethiol (Garg, N., Carrasquillo-Molina, E., Lee, T. R. Langmuir 2002, 18, 2717-2726) and 117 kJ/mol for docosanethiol (Bain, C. D., Troughton, E. B., Tao, Y. T., Evall, J., Whitesides, G. M., Nuzzo, R. G. J. Am. Chem. Soc. 1989, 111, 321-335), respectively. Using an increase of desorption energy of 0.8 kJ/mol per methylene unit (Bain, C. D., Troughton, E. B., Tao, Y. T., Evall, J., Whitesides, G. M., Nuzzo, R. G. J. Am. Chem. Soc. 1989, 111, 321-335), the activation energy of desorption of decanethiol was calculated to be 104 kJ/mol in isooctane and 107 kJ/mol in decalin, respectively, which is consistent with estimations.

More desorption is expected if the oxidation pathway is also activated at the same time. Addition of a small amount DMF or DMSO molecules increased desorption barriers by stabilizing SAMs, especially adsorbates at defects sites. Solvation energy of thiols (or disulfides) remained largely unchanged in comparison to pure water since the DMF or DMSO concentration is small. In other words, amphiphilic molecules, such as DMF and DMSO, increased the activation barrier of desorption by decreasing the free energy of the reactants, hence blocking both degradation pathways. The corresponding adsorption energy of DMSO on SAMs was estimated to be 15 kJ/mol, compared to 2.9 kJ/mol for water molecules (Vieceli, J., Benjamin, I. Langmuir 2003, 19, 5383-5388). The activation barrier of desorption in DMSO aqueous solutions thus becomes 120 kJ/mol. Assuming first-order desorption and a preexponential factor of 10¹³ s⁻¹, Arrhenius calculation yielded a rate constant of 1.4×10⁻⁸ s⁻¹ for desorption, or the half-life of decanethiol SAMs to be 573 days at room temperature. Based on the desorption experiments at elevated temperatures, the activation barrier of desorption in 5% DMF in water was estimated to be 115 kJ/mol, close to the calculated value for DMSO. Adding a small amount DMF or DMSO in water unexpectedly provided an extremely simple and effective way to preserve SAMs by inhibiting both degradation pathways through adsorption of amphiphilic molecules at defect sites and on the well-ordered areas. The desorption kinetics can be regulated by varying the concentration of the surfactants.

### Example 10

### Fabrication of Nanometer Structures with Various Functionalities

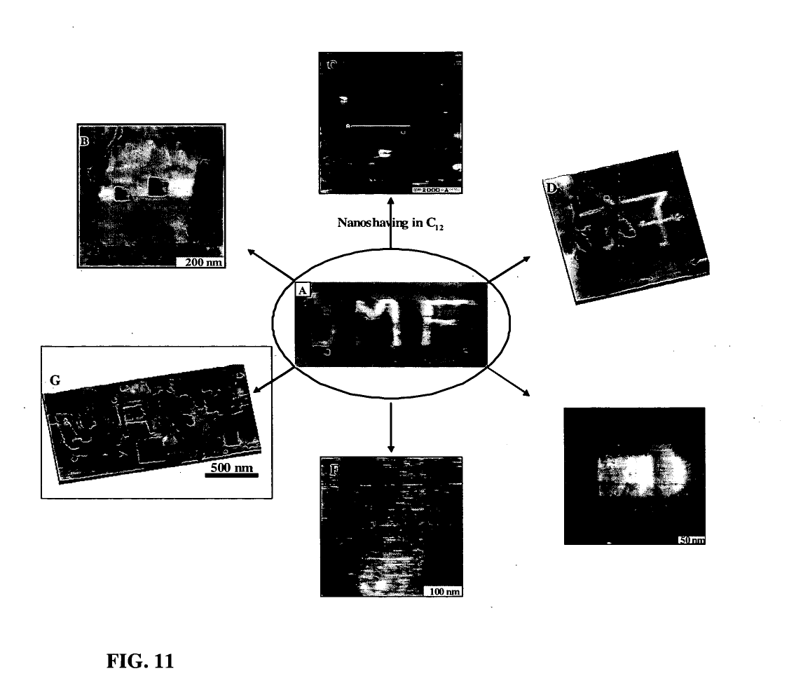

Nanografting has been used to make nanofeatures as small as 2×4 nm², and molecules within the patterns are closely packed (Xu, S.; Liu, G. Y. Langmuir 1997, 13, 127-129; Liu, G. Y.; Xu, S.; Qian, Y. L. Accounts of Chemical Research 2000, 33, 457-466). Patterns with multiple components and various geometries can be produced such as lines, squares and rectangles. More complicated patterns can also be fabricated, including the example shown in FIG. 11 which shows AFM images of the pattern “DMF” which was fabricated on a decanethiol SAM on Au(111) and was initially imaged in the ternary mixture of 5% DMF/water containing 0.1 mM octadecanethiol molecules. The acronym of dimethylformamide (“DMF”) was grafted into the matrix, as shown in the AFM topography image FIG. 11A. The line width of the fabricated letters was 42 nm. The letters exhibited positive contrast in the topographic image because the chain length of octadecanethiol is 0.9±0.1 nm higher than the matrix material. Together the height measurements and the molecular resolution images obtained from AFM indicated that the chains were closely packed within the nanoislands.

Nanostructures with various functionalities and complex architectures were produced in water environment, such as —CH₃, —CF₃, —CHO, —COOH, —SH, —OH, and -biotin. A selection of the AFM images obtained for these nanostructures are depicted, as labeled, in FIG. 11 (B-G), and described in more detail below.

FIG. 11B illustrates the fabrication of multiple patterns. First, a square C₁₈S pattern 400×400 nm² was produced within a hydrophobic SAM matrix (C₁₀) by nanografting in DMF/water mixed solvent. After the fabrication the mixed solvent was then replaced with a 0.1 mM HS(CH₂)₂COOH solution. Two square patterns, 70×70 nm² and 90×90 nm², with a spacing of 100 nm of HOOC(CH₂)₂SH was grafted on top of the prefabricated octadecanthiol. The two HOOC(CH₂)₂SH patterns were 7±1 Å and 15±1 Å shorter than the decanethiol matrix and the octadenathiol pattern. The height measurements indicate that the chains are closely packed within the nanoislands.

FIG. 11C shows that in air or pure water, where thiols exhibit little solubility, most of the displaced molecules remained weakly attached to the gold substrate. Therefore, the displacement was, at least in part, reversible and cannot be used to pattern thiol SAMs. Use of organic solvents in which thiols exhibit greater solubility, such as sec-butanol, patterns were able to be produced. To be able to nanoshave in water, a binary mixture of 5% DMF/water was added to the liquid cell. FIG. 11C shows a 150×150 nm² square hole within a C₁₂S/Au(111) layer produced in aqueous media.

FIG. 11D shows the Chinese word for “molecule” nanografted onto a decanethiol matrix. Prior to fabrication, a decanethiol SAM was imaged in a ternary mixture of 5% DMF/water containing 0.1 mM octadecanethiol molecules. The Chinese word for “molecule” was then grafted onto the matrix. The line width of the fabricated letters is 35 nm. The letters exhibits positive contrast in the topographic image due to the difference in chain length between octadecanethiol and the matrix.

FIG. 11E shows a 100×100 nm² aldehyde terminated positive pattern grafted onto a hexanethiol SAM in a ternary mixture of 5% DMF/Water containing 0.1 mM of HS(CH2)₁₀CHO. The fabricated structure is 5.0±1.0 Å higher than the matrix.

FIG. 11F shows a 150×150 nm² HS(CH₂)₁₅COOH square nanopattern, grafted within a matrix of decanethiol on Au(111). The patterning and imaging of SAMs were conducted in a ternary mixture of 5% DMF/water containing 0.1 mM HS(CH₂)₁₅COOH.

FIG. 11G shows several aldehyde-terminated negative patterns of C₁₀CHO that were grafted onto a C₁₈ SAM in a ternary mixture of DMF/water/thiol mixture. Three square patterns with sizes 250×250 nm², 100×100 nm², and a third pattern in the upper right corner, contain mixed dodecanethiol and mercaptoundecanal, with a size of 300×300 nm², resulting from incomplete removal of matrix SAM during nanografting. The two letters “NA” have a line width of 25 nm. The depth of these negative patterns is 6.0±1.0 Å, in good agreement with the theoretical height difference between the SAM and the patterns.

The ability to produce multiple patterns with different shapes and geometries in precise locations in aqueous solvents satisfies a basic requirement for fabrication of various sensor arrays, which requires an aqueous media. Other than the simplicity of producing patterns in water-based solvents, the introduction of DMF makes this process more straightforward than current state-of-the-art processes for subsequent immobilization of biomolecules such as proteins onto the nanostructures. This is due to the simplicity in solvent exchange when using water-based solvents in contrast to previous systems that required transfer from an organic phase to an aqueous phase to maintain the activity and structure of biomolecules such as proteins or antibodies.

### Example 11

### Production and Activity Preservation of Protein Nanostructures in Aqueous Media

As part of the development of systems using nanografting in aqueous solution for an antigenically addressable system suitable for height based Scanning Force Microscopy Immunoassays (SFMI), an aldehyde-terminated pattern capable of binding rabbit IgG antigen was grafted onto the matrix. It has been shown, in previous studies using in situ and real time imaging on functionalized SAMs that tobacco mosaic virus capsid protein, tobacco etch virus capsid proteins, and BSA can bind antibodies specifically after immobilization on carboxylic acid terminated SAMs (WaduMesthrige, K.; Pati, B.; McClain, W. M.; Liu, G. Y. Langmuir 1996, 12, 3511-3515). This observation is consistent with results from other studies using fluorescence microscopy (Jones, V. W.; Kenseth, J. R.; Porter, M. D.; Mosher, C. L.; Henderson, E. Anal. Chem. 1998, 70, 1233-1241; Lahiri, J.; Ostuni, E.; Whitesides, G. M. Langmuir 1999, 15, 2055-2060). The AFM experiments described in more detail below confirmed that immobilized antibodies such as IgG on nanopatterns retained their reactivity upon reaction with anti-IgG antibodies.

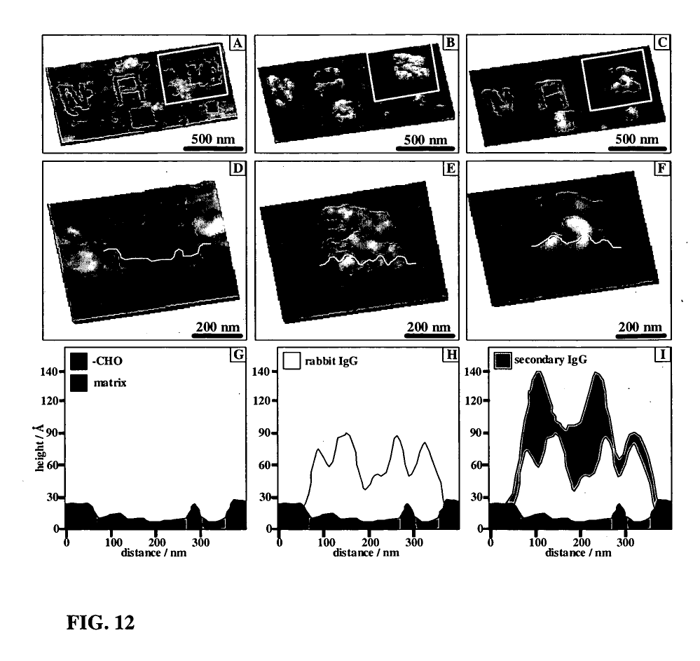

FIG. 12 shows AFM topographs of a system in which the bioactivity of immobilized rabbit IgG was tested by measuring the reactivity to mouse anti-rabbit IgG. In FIG. 12A, several aldehyde-terminated nanopatterns were first grafted in the ternary mixture of 5% DMF/water/thiol. Three square patterns with sizes 250×250 nm², 100×100 nm², and a third pattern in the upper right corner, with a size of 300×300 nm² were fabricated and contained mixed dodecanethiol and mercapto-undecanal. The third pattern in the upper right resulted from the incomplete removal of matrix SAM during nanografting. A smaller fabrication force was used on the upper right pattern. As shown in FIG. 12A-C, the two letters “N” and “A” were clearly visible and the measured line width was 25 nm. Gold steps and defects were clearly visible after fabrication (see FIG. 12A). The depth of these negative patterns was 6.0±10.0 Å, in good agreement with the theoretical height difference between the SAM and the nanopatterns.

The liquid cell was then washed with a pure DMF/water mixture followed by water wash and switching to PBS buffer. Each of these procedures was performed without loosing the fabricated area. Contamination of organic solvent in the liquid cell, which denatures the proteins, was also avoided. After the injection of 0.01 mg/ml solution of rabbit IgG (PBS buffer), adsorption was observed on all five patterns. Some nonspecific adsorption on the matrix area was also observed. The IgG molecules on the methyl-terminated area of the matrix (the background) were easily removed by rinsing with a surfactant solution (1% TWEEN® 20 (Polyoxyethylene(20) sorbitan monolaurate), resulting in the highly stable immobilized pattern shown in FIG. 12B.

As demonstrated, there was a clear increase in the height of the topography after the injection of proteins, as shown in FIGS. 12A and 12B. The bound IgG was on average 5-7 nm higher than the octadecanethiol matrix. The specific recognition of the fabricated antigenic address by anti-rabbit IgG is demonstrated in FIG. 12C. Prior to the injection of the secondary antibodies the rabbit IgG in solution was removed. FIG. 12C shows the same region of the surface presented in FIGS. 12A and 12B, but after 10 min exposure to mouse anti-rabbit IgG. An increase in height of 5-12 nm was observed after the injection of the mouse anti-rabbit IgG, indicating the attachment of the secondary antibody. Such a wide height range is expected because the rabbit IgG molecules within the patterns have various orientations on the surfaces. Higher-resolution topographic images are shown for the mixed SAM nanopattern within the white frame (FIG. 12D-F). The height of the nanopatterns is alto presented in a more quantitative fashion in the cursor profiles shown in FIG. 12G-I. Interestingly, it was noted that the adsorption of protein was not observed on the matrix after surfactant wash, thus it is likely that the ternary mixture prevented exchange reactions (Xu, S.; Liu, G. Y. Langmuir 1997, 13, 127-129; Xu, S.; Miller, S.; Laibinis, P. E.; Liu, G.-Y. Langmuir 1999, 15, 7244-7251) between thiol molecules in solution and the thiol molecules of the matrix.

The bioactivity of proteins was preserved after exposure to the binary mixture DMF/water, and other studies have shown that 5% DMF does not change the antigen-binding activity of antibodies (Melnikova, Y. I.; Odinstov, S. G.; Kravchuk, Z. I.; Martsev, S. P. Biochemistry-Moscow 2000, 65(11), 1256-1265). Taken together, these data support the finding that AFM can be used to fabricate address elements for subsequent use in height-based SFMI.

### Example 12

### Preserving Micro and Nanostructures of Templated Proteins for Binding Assays

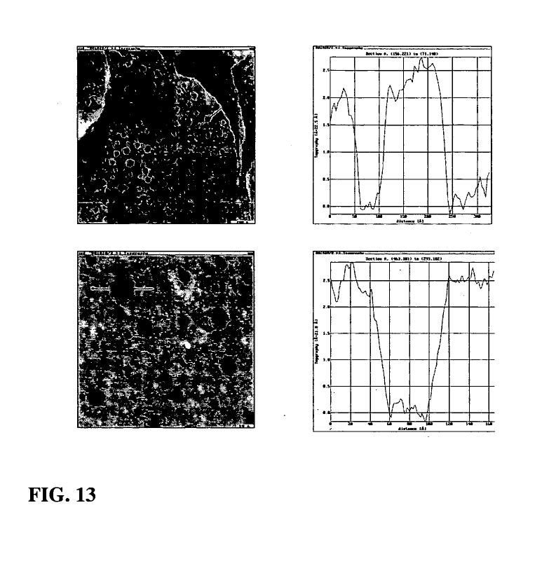

In FIG. 5 and Example 6 (see also Yang, G. H.; Amro, N. A.; Starkewolfe, Z. B.; Liu, G. Y. Langmuir 2004, 20, 3995-4003), it is demonstrated that addition of DMF to aqueous media preserves nanostructures and the SAMs surrounding the nanostructures. In addition, as described below, nanodomains and SAMs formed from natural growth via conventional wet chemistry method are also preserved. FIG. 13 depicts a system incorporating a mixed SAM formed by co-adsorption of —CH₃(CH₂)₅SH and —CH₃(CH₂)₉SH on gold.

The SAM was soaked in a mixed DMF/water (5%/95%) solvent for 36 day. STM topographs revealed the typical structural features of SAMs, e.g., etch pits, which indicate the integrity of this layer. In microfabrication applications where SAMs are used as resists, the layer is formed either by soaking pure or mixed thiols on metals. These results show that the 5% DMF/water also preserved naturally grown SAMs as well as engineered nanostructures of SAMs. Thus, demonstrating that the addition of DMF preserved the integrity of SAMs at molecular level. Therefore, this method may be used to preserve SAMs, nano and microstructures, especially before, during or after nano and microfabrication processes.

1. A stabilized system comprising
(a) a solid support;
(b) a surface-layer bonded to at least a portion of a surface of the solid support; and
(c) a stabilizing solution contacted with at least a portion of the surface-layer;
wherein the stabilizing solution comprises a solvent and a stabilizing component and wherein the stabilizing component comprises molecules having a solvent-philic portion and a surface-layer-philic portion.

2. The stabilized system of claim 1, wherein at least a portion of the surface of the solid support is a metal surface, a semiconductor surface, a metal thin film, or an insulator surface.

3. The stabilized system of claim 2, wherein at least a portion of the surface of the solid support is a gold surface, silver surface, platinum surface, palladium surface or copper surface.

4. The stabilized system of claim 2, wherein the solid support comprises a metal thin film on a mica surface, a silicon wafer surface, a glass surface, a quartz surface, a plastic surface, a polymeric surface or a waveguide.

5. The stabilized system of claim 4, wherein the metal thin film is gold.

6. The stabilized system of claim 1, wherein at least a portion of the surface-layer is a monolayer, a multilayer, or a thin film.

7. The stabilized system of claim 6, wherein the monolayer is a self-assembled monolayer.

8. The stabilized system of claim 6, wherein at least a portion of the surface-layer is a self-assembled monolayer made of molecules each containing at least one surface-adhesive head group, a linker group and at least one terminal group.

9. The stabilized system of claim 7, wherein at least a portion of the surface-layer is a self-assembled monolayer made of alkyl containing molecules.

10. The stabilized system of claim 8, wherein at least one surface-adhesive head group is a thiol.

11. The stabilized system of claim 8, wherein the linker group contains an alkyl group, polyethylene glycol, an amide group, or combinations thereof.

12. The stabilized system of claim 7, wherein the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD or a -carbohydrate,
wherein each R¹ and R² is, independently, a straight or branched chain alkyl or aryl.

13. The stabilized system of claim 9, wherein the alkyl containing molecules contain a C₁-C₃₀ alkyl group, at least a portion of the solid support surface is a gold surface, and the alkyl containing molecules are bonded to the gold surface via a thiol moiety.

14. The stabilized system of claim 1, wherein the surface of the solid support is immersed in the stabilizing solution.

15. The stabilized system of claim 1, wherein the solvent is water, an aqueous solvent, an aqueous buffer, an organic solvent, a protic solvent, an aprotic solvent or,
wherein the solvent is a mixture of two or more of water, an aqueous solvent, an aqueous buffer, an organic solvent, a protic solvent, or an aprotic solvent.

16. The stabilized system of claim 15, wherein the solvent is an aqueous buffer.

17. The stabilized system of claim 15, wherein the solvent is water.

18. The stabilized system of claim 15, wherein the solvent comprises minor components of non-reactive additives with a concentration of less than 15% mole fraction.

19. The stabilized system of claim 1, wherein the stabilizing component contains amphiphilic molecules.

20. The stabilized system of claim 19, wherein the solvent is an aqueous buffer.

21. The stabilized system of claim 1, wherein the solvent is water or an aqueous buffer, and the stabilizing component contains molecules of the formula AB, wherein,
A is a solvent-philic moiety; and,
Bₙ is a surface-philic moiety,
where n is 1, 2 or 3.

22. The stabilized system of claim 21, wherein,
A contains an amide, —OH, ether, ester, amine, or sulfoxide; and, each B is, independently, a straight or branched alkyl group or aryl group.

23. The stabilized system of claim 22, wherein A is a formamide, a sulfoxide, or an acetamide.

24. The stabilized system of claim 22, wherein the solvent is water or aqueous buffer and the stabilizing component contains N,N-dimethylformamide, dimethyl sulfoxide, N,N-dimethylacetamide, N-methylformamide, or a mixture of two or more thereof.

25. The stabilized system of claim 1, wherein the stabilizing component contains molecules that associate preferentially with defect sites in the surface-layer.

26. The stabilized system of claim 25, wherein the defect sites are one or more of domain boundaries, holes, pits, cracks, dislocations, island edges, or step edges.

27. The stabilized system of claim 1, wherein the concentration of the stabilizing component in the stabilizing solution is equal to or less than about 45% by volume.

28. The stabilized system of claim 26, wherein the concentration of the stabilizing component is between about 0.01% by volume and about 15% by volume.

29. A stabilized surface-layer, comprising
(a) a self-assembled monolayer, each molecule of the self-assembled monolayer containing a C₁-C₃₀ alkyl linker, a head group bonded to at least a portion of a surface of a solid support and at least one terminal group; and
(b) a stabilizing solution contacting at least a portion of the self-assembled monolayer;
wherein the stabilizing solution comprises water and a stabilizing component containing amphiphilic molecules.

30. The stabilized surface-layer of claim 29, wherein the stabilizing component contains N,N-dimethylformamide, dimethyl sulfoxide, N,N-dimethylacetamide, N-methylformamide or a mixture of two or more thereof.

31. The stabilized surface-layer of claim 29, wherein the concentration of the stabilizing component in the stabilizing solution is equal to or less than about 45% by volume.

32. The stabilized surface-layer of claim 31, wherein the concentration of the stabilizing component is between about 0.1% by volume and about 15% by volume.

33. The stabilized surface-layer of claim 32, wherein the concentration of the stabilizing component is between about 2% by volume and about 8% by volume.

34. The stabilized surface-layer of claim 30, wherein the stabilizing component contains dimethyl sulfoxide molecules, N,N-dimethylformamide molecules, or a mixture thereof.

35. The stabilized surface-layer of claim 29, wherein the surface-layer is immersed in the stabilizing solution.

36. A stabilized surface-layer, comprising
(a) a solid support comprising a pre-engineered surface-layer; and
(b) a stabilizing solution contacting at least a portion of the surface-layer;
wherein the stabilizing solution comprises a solvent and a stabilizing component and wherein the stabilizing component comprises molecules having a solvent-philic portion and a surface-layer-philic portion.

37. The stabilized surface-layer of claim 36, wherein the stabilizing component contains molecules of N,N-dimethylformamide, dimethyl sulfoxide, N,N-dimethylacetamide, N-methylformamide or a mixture of two or more thereof.

38. The stabilized surface-layer of claim 36, wherein the concentration of the stabilizing component in the stabilizing solution is equal to or less than about 45% by volume.

39. The stabilized surface-layer of claim 38; wherein the concentration of the stabilizing component is between about 0.01% by volume and about 15% by volume.

40. The stabilized surface-layer of claim 39, wherein the concentration of the stabilizing component is between about 0.1% by volume and about 15% by volume.

41. The stabilized surface-layer of claim 36, wherein the stabilizing component contains dimethyl sulfoxide molecules, N,N-dimethylformamide molecules, or a mixture thereof.

42. The stabilized surface-layer of claim 36, wherein the surface-layer is immersed in the stabilizing solution.

43. The stabilized surface-layer of claim 36, wherein the solvent is water or aqueous buffer and the stabilizing component is an amphiphilic molecule or mixture of amphiphilic molecules.

44. The stabilized surface-layer of claim 43, wherein the stabilizing component contains molecules of N,N-dimethylformamide, dimethyl sulfoxide, N,N-dimethylacetamide, N-methylformamide or a mixture of two or more thereof.

45. The stabilized surface-layer of claim 36, wherein the pre-engineered surface-layer contains microstructures, nanostructures, or a mixture thereof.

46. The stabilized surface-layer of claim 45, wherein the microstructures, nanostructures, or mixture thereof are surrounded by a monolayer, multilayer or thin film.

47. The stabilized surface-layer of claim 46, wherein the monolayer is a self-assembled monolayer.

48. The stabilized surface-layer of claim 45, wherein the microstructures are prepared by microcontact printing, photolithography, micromachining, soft lithography, or a combination of one or more thereof.

49. The stabilized surface-layer of claim 45, wherein the nanostructures are prepared by nanografting, scanning probe lithography, mixing of multicomponents, nanoimprint, x-ray lithography, dip pen nanolithography, e-beam lithography, atom lithography, or a combination of two or more thereof.

50. The stabilized surface-layer of claim 36, wherein at least a portion of the pre-engineered surface-layer is a self-assembled monolayer made of molecules each containing at least one surface-adhesive head group, a linker group and at least one terminal group.

51. The stabilized surface-layer of claim 50, wherein the surface-adhesive head group is a thiol and the linker is a C₁-C₃₀ alkyl group.

52. The stabilized surface-layer of claim 51, wherein the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD or a -carbohydrate,
wherein each R¹ and R² is, independently, a straight or branched chain alkyl or aryl.

53. The stabilized surface-layer of claim 45, wherein at least a portion of the surface-layer is a self-assembled monolayer made of molecules each containing at least one surface-adhesive head group, a linker group and at least one terminal group.

54. The stabilized surface-layer of claim 53, wherein the surface-adhesive head group is a thiol and the linker is a C₁-C₃₀ alkyl group.

55. The stabilized surface-layer of claim 54, wherein the at least one terminal group is, independently, one or more of —CH₃, —CF₃, —OH, —CHO, —COOH, —NH₂, —NHR¹, —NR¹₂, —NR¹R², OCH₂CH₃, —SH, -biotin, -phenyl, an —RGD or a -carbohydrate,
wherein each R¹ and R² is, independently, a straight or branched chain alkyl or aryl.

56. The stabilized surface-layer of claim 55, wherein the pre-engineered surface layer further comprises one or more biomolecules.

57. The stabilized surface-layer of claim 56, where the one or more biomolecule are, independently, antibodies, oligonucleotides, DNA, RNA, oligopeptides, peptides, proteins, or a mixture of two or more thereof.

58. The stabilized surface-layer of claim 51, wherein the at least one terminal group is, independently, one or more of —CH₃, —CF₃, —OH, —CHO, —COOH, —NH₂, —NHR¹, —NR¹₂, —NR¹R², —OCH₂CH₃, —SH, -biotin, -phenyl, an —RGD or a -carbohydrate,
wherein each R¹ and R² is, independently, a straight or branched chain alkyl or aryl.

59. The stabilized surface-layer of claim 36, wherein the pre-engineered surface layer further comprises one or more biomolecules.

60. The stabilized surface-layer of claim 59, where the one or more biomolecule are, independently, antibodies, oligonucleotides, DNA, RNA, oligopeptides, proteins, peptides, or a mixture of two or more thereof.

61. A kit for use in stabilizing a system, the kit comprising a stabilizing solution and instructions for contacting the stabilizing solution with a surface-layer bonded to the surface of a solid support; wherein the stabilizing solution comprises a solvent and a stabilizing component containing amphiphilic molecules.

62. The kit of claim 61, wherein the solvent is water.

63. The kit of claim 61, wherein the solvent is an aqueous buffer.

64. The kit of claim 63, wherein the amphiphilic molecules are N,N-dimethylformamide, dimethylsulfoxide, N,N-dimethylacetamide, N-methylformamide or a mixture of two or more thereof.

65. The kit of claim 64, wherein the concentration of the stabilizing component in the stabilizing solution is equal to or less than about 45% by volume.

66. The kit of claim of claim 65, wherein the concentration of the stabilizing component is between about 0.01% by volume and about 15% by volume.

67. The kit of claim 66, wherein the concentration of the stabilizing component is between about 2% by volume and about 8% by volume.

68. The kit of claim 67, wherein the stabilizing component contains dimethylsulfoxide molecules, N,N-dimethylformamide molecules, or a mixture thereof.

69. A method for stabilizing a surface-layer bonded to at least a portion of a surface of the solid support, the method comprising contacting the surface-layer with a fluid comprising a stabilizing component containing molecules that associate preferentially with defect sites in the surface-layer.

70. The method of claim 69, wherein the stabilizing component is dissolved in a solvent.

71. The method of claim 70, wherein the molecules that associate preferentially with defect sites in the surface-layer are amphiphilic molecules.

72. The method of claim 71, wherein the stabilizing component is dissolved in water or aqueous buffer.

73. The method of claim 72, wherein the amphiphilic molecules are N,N-dimethylformamide, dimethylsulfoxide, N,N-dimethylacetamide, N-methylformamide or a mixture of two or more thereof.

74. The method of claim 73, wherein the concentration of the stabilizing component in the stabilizing solution is equal to or less than about 45% by volume.

75. The method of claim of claim 74, wherein the concentration of the stabilizing component is between about 0.01% by volume and about 15% by volume.

76. The method of claim 75, wherein the concentration of the stabilizing component is between about 2% by volume and about 8% by volume.

77. The method of claim 76, wherein the amphiphilic molecules are dimethylsulfoxide, N,N-dimethylformamide, or a mixture thereof.
